(19) United States
(12) Patent Application Publication
(10) Pub. No.: US 2025/0315001 A1
(43) Pub. Date: Oct. 9, 2025

(54) IMAGE FORMING APPARATUS FOR FORMING TONER IMAGE FOR ADHERING FOIL ONTO SHEET

(71) Applicant: CANON KABUSHIKI KAISHA, Tokyo (JP)

(72) Inventors: Daisuke Katayama, Chiba (JP); Tohru Nakaegawa, Chiba (JP); Shingo Hirota, Ibaraki (JP); Shuichi Tamura, Ibaraki (JP); Ryohei Terada, Chiba (JP); Kota Kurokawa, Chiba (JP); Shuhei Yasuda, Chiba (JP); Kenichiro Kitajima, Ibaraki (JP)

(21) Appl. No.: 19/093,553

(22) Filed: Mar. 28, 2025

(30) Foreign Application Priority Data
Apr. 3, 2024 (JP) 2024-060400

(51) Int. Cl. G03G 15/00

(52) U.S. Cl. CPC G03G 15/6585; G03G 15/5016; G03G 15/5087; G03G 15/6544; G03G 2215/00835

(57) ABSTRACT

An image forming apparatus accepts a selection of a predetermined print mode for forming a toner image for adhering foil onto a sheet via the toner image and an input of information related to a grammage of the sheet. The apparatus forms the toner image on the sheet. The apparatus control a display unit to display a warning according to the information related to the grammage of the sheet in a case where the predetermined print mode is selected.

### BACKGROUND OF THE INVENTION

### Field of the Invention

The present invention relates to an image forming apparatus for forming a toner image for adhering foil onto a sheet.

### Description of the Related Art

Foil printing technology is used in the fields of bookbinding, commercial printing, card business, and plastic molding for cosmetic containers, among others. Text or designs made of foil can achieve a metallic feel that is difficult to express with printing and provide a glossy finish. Foil printing is also used for holograms of credit cards and the like. According to Japanese Patent Laid-Open No. 2017-156723 and Japanese Patent Laid-Open No. 2021-116185, there has been proposed a foil printer in which a toner image is formed on a sheet in advance, and foil is transferred onto the sheet by using the toner image as an adhesive.

However, when the foil is adhered to the sheet via the toner, there is a possibility that a defect will occur in adhesion of the foil depending on the grammage of the sheet.

### SUMMARY OF THE INVENTION

The present disclosure provides an image forming apparatus comprising: an input unit configured to accept a selection of a predetermined print mode for forming a toner image for adhering foil onto a sheet via the toner image and an input of information related to a grammage of the sheet; an image forming unit configured to form the toner image on the sheet; and a display unit configured to display a warning according to the information related to the grammage of the sheet in a case where the predetermined print mode is selected.

Further features of the present invention will become apparent from the following description of exemplary embodiments with reference to the attached drawings.

### BRIEF DESCRIPTION OF THE DRAWINGS

FIG. 1 is a drawing illustrating an image forming system.

FIGS. 2A and 2B are drawing illustrating foil processing.

FIGS. 3A and 3B are drawings illustrating a user interface.

FIG. 4 is a drawing illustrating a controller.

FIG. 5 is a flowchart showing a control method

FIG. 6 is a drawing illustrating a user interface.

FIG. 7 is a drawing illustrating a user interface.

FIG. 8 is a drawing illustrating a user interface.

FIG. 9 is a drawing illustrating a controller.

FIG. 10 is a flowchart showing a control method

FIG. 11 is a drawing illustrating a user interface.

FIG. 12 is a drawing illustrating a controller.

FIG. 13 is a flowchart showing a control method

FIG. 14 is a drawing illustrating a user interface.

FIG. 15 is a drawing illustrating a controller.

FIG. 16 is a flowchart showing a control method

FIG. 17 is a drawing illustrating an image forming system.

FIG. 18 is a drawing illustrating an image forming system.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### I. First Embodiment

### 1. Image Forming System (Foil Printing System)

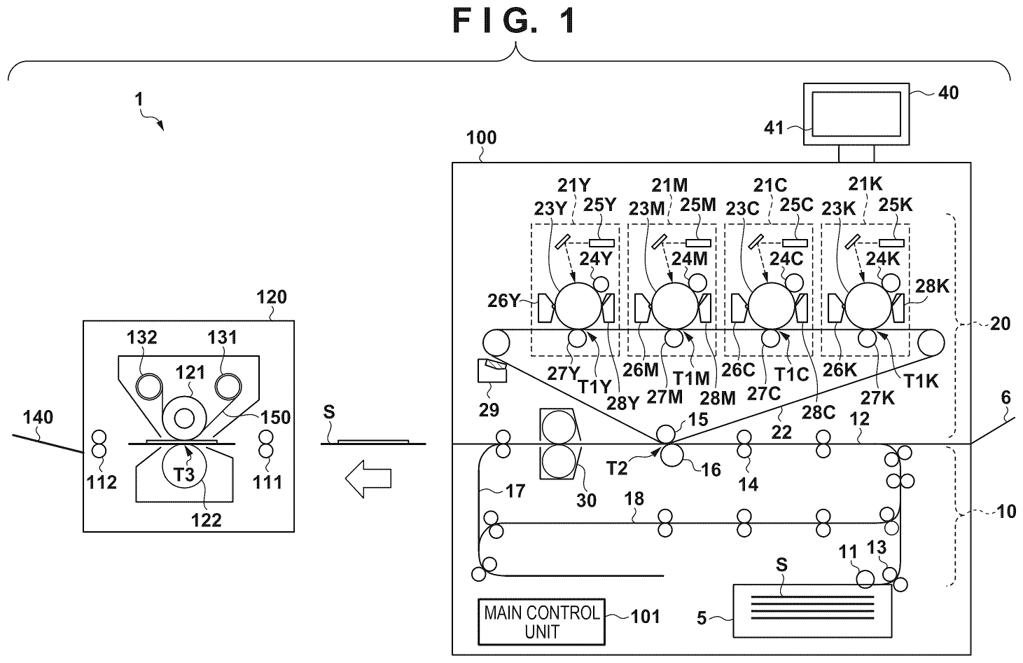

As shown in FIG. 1, an image forming system 1 includes an image forming apparatus 100 and a foil printer 120. The image forming apparatus 100 forms a toner image on a sheet (also referred to as a recording material) S. The foil printer 120 prints foil onto the sheet S using a toner of the toner image as a glue.

The image forming system 1 is a so-called offline type system in which the foil printer 120 is not mechanically coupled to image forming apparatus 100.

In this case, the sheet S on which the toner image is formed is discharged from image forming apparatus 100 and then manually inserted into the foil printer 120 by a user (see an arrow in the drawing). In other embodiments, an inline type system may be provided in which the foil printer 120 is coupled to image forming apparatus 100. In this case, the sheet S is automatically transferred from image forming apparatus 100 to the foil printer 120. In yet another embodiment, an integrated printing device may be provided that incorporates the foil printing capability of the foil printer 120 into the interior of the image forming apparatus 100.

### 1-1. Image Forming Apparatus

The image forming apparatus 100 may be a color printer or a monochrome printer. In the example of FIG. 1, the image forming apparatus 100 is a tandem full color printer capable of forming full color images with an electrophotographic manner. The image forming apparatus 100 includes a cassette 5, a manual feed tray 6, a conveyance unit 10, an image forming unit 20, a fixing unit 30, an operation unit 40, and a main control unit 101.

The image forming unit 20 is an image forming unit including a process unit 21Y, 21M, 21C and a 21K, an intermediate transfer belt 22, and a belt cleaner 29. The process units 21Y, 21M, 21C and 21K are arranged in parallel along the moving direction of the intermediate transfer belt 22 to form toner images of yellow, magenta, cyan, and black, respectively. Note that Y, M, C, and K characters assigned to the end of the reference numerals in FIG. 1 may be omitted when the matters common to the four colors are described. The intermediate transfer belt 22 is stretched over a plurality of rollers and rotates. As will be described later, the toner images of the four color components are transferred to the intermediate transfer belt 22 and superimposed on each other (primary transfer), thereby forming a full-color toner image. The intermediate transfer belt 22 carries the full-color toner image and conveys it to a secondary transfer position T2.

The cassette 5 is an accommodation unit that accommodates a bundle of sheets. Although FIG. 1 shows an embodiment in which the image forming apparatus 100 includes only one cassette 5, the image forming apparatus 100 may include a plurality of cassettes 5 capable of accommodating sheets S of differing types (e.g., size, thickness, or presence or absence of surface-coating). In this case, the sheet S of the type designated in each job is fed from the corresponding cassette 5. Note that the sheet S may be fed from a manual feed tray 6 instead of the cassette 5. Further, the image forming system 1 may include a paper feeder (not illustrated) separate from image forming apparatus 100.

The conveyance unit 10 is a conveyance unit including a conveyance path and a plurality of rollers. The feeding roller 11 feeds the sheets one by one from the bundle of the sheets S in the cassette 5 to the conveyance path 12. The conveyance roller 13 conveys the sheet along the conveyance path 12. The registration roller 14 feeds the sheet S to the secondary transfer position T2 in synchronization with the timing at which the toner image on the intermediate transfer belt 22 reaches the secondary transfer position T2.

Since the configuration of the process unit 21Y, 21M, 21C and 21K may be similar to each other, they are referred to as a process unit 21. The process unit 21 includes a photosensitive drum 23, a charger 24, an exposure unit 25, a developing unit 26, a primary transfer roller 27, and a drum cleaner 28. The photosensitive drum 23 is a cylindrical image carrier and rotates in the counterclockwise direction in the drawing. The charger 24 may be, for example, a corona charger that irradiates charged particles by corona discharge, and charges the surface of the photosensitive drum 23 to a uniform potential (e.g. a negative dark portion potential). The charger 24 may have a roller or a wire for discharging. The exposure unit 25 includes, for example, a semiconductor laser as a light source, and scans the surface of the photosensitive drum 23 with a laser beam according to the input image data to form an electrostatic latent image on the surface of the photosensitive drum 23. The developing unit 26 accommodates, for example, a developer including a toner and a carrier in its interior, and develops the electrostatic latent image on the surface of the photosensitive drum 23 by supplying the developer to the photosensitive drum 23 to form a toner image.

As an example, the developer may be a two-component developer including a non-magnetic toner and a magnetic carrier. The toner may contain a binder resin, a colorant, and a release agent (wax).

A primary transfer roller 27 is disposed at a primary transfer position T1 so as to face the photosensitive drum 23. The primary transfer roller 27 is supplied with a primary transfer bias of high voltage and transfers the toner image (here, yellow) on the surface of the photosensitive drum 23 to the intermediate transfer belt 22. The drum cleaner 28 removes a toner remaining on the surface of the photosensitive drum 23 after the primary transfer.

Similar to the process unit 21Y, magenta, cyan, and black toner images are formed in the process units 21M, 21C and 21K, respectively. Then, these toner images are sequentially transferred and superimposed on the yellow toner image on the intermediate transfer belt 22.

A secondary transfer outer roller 16 is disposed at the secondary transfer position T2 so as to face a secondary transfer inner roller 15, which is one of the rollers over which the intermediate transfer belt 22 is stretched. The secondary transfer outer roller 16 is supplied with a secondary transfer bias of high voltage and transfers the full-color toner image carried by the intermediate transfer belt 22 to the sheet S that has reached the secondary transfer position T2 (secondary transfer). The belt cleaner 29 removes a toner remaining on the intermediate transfer belt 22 after the secondary transfer.

The fixing unit 30 is a fixing unit disposed downstream of the secondary transfer position T2. The fixing unit 30 includes a fixing roller (or a cylindrical heating film) and a pressure roller, and fixes the toner image on the sheet S by heating and pressing the sheet S on which the toner image has been transferred. The sheet S that has passed through the fixing unit 30 is discharged to the outside of the image forming apparatus 100 (e.g. to a discharge tray (not illustrated).

When double-side printing is executed, the sheet S on which the toner image is formed on the first surface is conveyed to the conveyance path 17. Therefore, the sheet S reverses the traveling direction and enters the conveyance path 18 for double-side printing. The sheet S returns to the conveyance path 12 with its front and back sides reversed. The toner image is transferred to the second surface of the sheet S at the secondary transfer position T2.

The fixing unit 30 fixes the toner image on the second surface of the sheet S by heating and pressing the sheet S again. Then, the sheet S is discharged to the outside of the image forming apparatus 100.

The operation unit 40 is an operation unit that provides a user interface to a user of the image forming system 1. The operation unit 40 includes, for example, a touch panel 41. The touch panel 41 displays an image and information according to control by a main control unit 101 described later, and accepts a touch input by a user. The operation unit 40 may include an output device (e.g. a liquid crystal display or a speaker) and an input device (e.g. a button, a switch, a keypad, or a microphone) instead of (or in addition to) the touch panel 41.

The main control unit 101 is a control unit that controls the overall operation of image forming apparatus 100. For example, the main control unit 101 controls the image forming unit 20 to form an image on the sheet S based on input image data received from an external device when the execution of the print job is instructed. The external device here may be, for example, a personal computer (PC) or an external controller. Although not shown in FIG. 1, the image forming apparatus 100 may further include a document reading unit. That is, the image forming apparatus 100 may be a multifunction peripheral. In this example, when the execution of the copy job is instructed, the main control unit 101 controls the image forming unit 20 to form an image on the sheet S based on the read image data generated by the scanner unit reading the document.

### 1-2. Foil Printer (Foil Processing Equipment)

The foil printer 120 includes a conveyance roller 111, a discharge roller 112, a heating roller 121, a pressure roller 122, a supply reel 131, a retrieval reel 132, and a discharge tray 140.

The conveyance roller 111 receives the sheet S on which the toner image is formed, and feeds the sheet S to an adhering position T3. At the adhering position T3, the heating roller 121 and the pressure roller 122 are disposed so as to face each other. The supply reel 131 is wound with a foil sheet 150 composed of foil and a film-shaped holding member for holding the foil. The leading end of the foil sheet 150 is fixed to the retrieval reel 132.

The supply reel 131 and the retrieval reel 132 suspend the foil sheet 150 via the lower surface of the heating roller 121 while maintaining a predetermined tension so as not to cause wrinkles in the foil sheet 150. Although not shown in FIG. 1, the foil printer 120 may include additional suspension rollers to stably maintain the tension of the foil sheet 150. The supply reel 131 rotates in the clockwise direction in the drawing to supply the foil sheet 150 to the adhering position T3. The heating roller 121 heats the sheet S that has reached the adhering position T3. Accordingly, a result, at least one type of toner used as a glue (adhesive) among the toners constituting the toner image melts. The pressure roller 122, together with the heating roller 121, presses the foil sheet 150 against the sheet S. As a result, the melted toner acts as a glue, and the foil on the foil sheet 150 is adhered to the sheet S via the toner. The retrieval reel 132 rotates in the counterclockwise direction in the drawing, and winds up the foil sheet 150. At this time, the foil on the foil sheet 150 is peeled off from the support member and adhered to the sheet S to form an image of the foil on the sheet S. The discharge roller 112 discharges the sheet S that has passed through the adhering position T to the discharge tray 140.

### 1-3. Foil

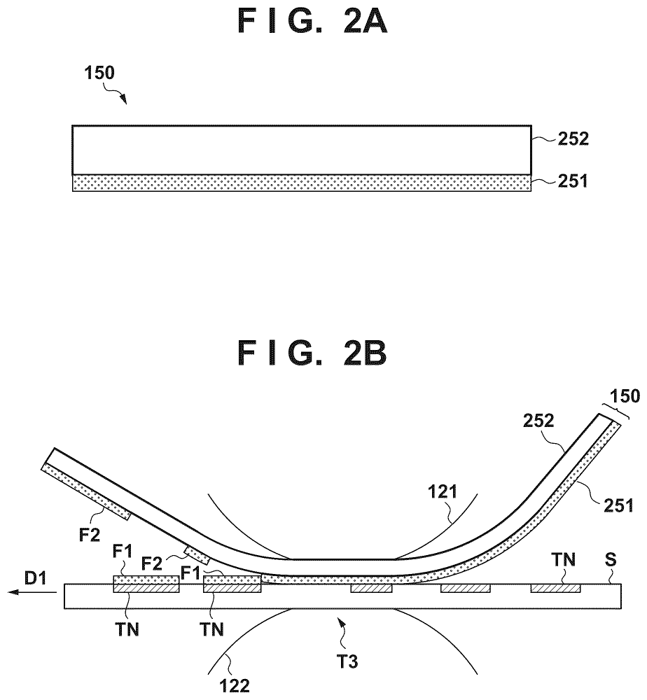

FIG. 2A shows an example of the construction of the foil sheet 150. The foil sheet 150 includes a foil layer 251 and a backup layer 252. The foil layer 251 is a sheet-like layer made of a metal material. The metal material of the foil layer 251 may be, for example, aluminum, tin, silver, copper, chromium, nickel, gold, or iron, or an alloy of two or more thereof (e.g., nickel-chromium steel, bronze, or aluminum bronze). The backup layer 252 is a sheet-like layer made of resin that supports the foil layer 251. The resin material of the backup layer 252 may be, for example, polyethylene terephthalate (PET), polyethylene naphthalate (PEN), polypropylene (PP), polyether sulfone (PES), or polyimide (PI).

### 1-4. Formation of Foil Images

FIG. 2B shows an enlarged view of the vicinity of the adhering position T3 while the foil printer 120 is operating. In this example, the heating roller 121 positioned on the adhering position T3 and the pressure roller 122 positioned below the adhering position T3 nip the sheet S on which the toner image TN is formed and the foil sheet 150. The heating roller 121 and the pressure roller 122 rotate according to the rotation of the retrieval reel 132 driven by a motor (not illustrated), and convey the sheet S and the foil sheet 150 toward the conveyance direction D1.

The surface temperature of the heating roller 121 is controlled so that the temperature of the toner in the toner image TN reaches the melting point. This temperature is, for example, from 140° C. to 180° C. When the temperature of the toner reaches the melting point at the adhering position T3, the toner melted and increased in viscosity acts as a glue. The toner image TN is further pressed by the pressure roller 122 to adhere to the foil layer 251 of the foil sheet 150. Therefore, when the sheet S and the foil sheet 150 pass through the adhering position T3, the foil F1 of the foil layer 251 in contact with the toner image TN is peeled off from the backup layer 252 while being adhered to the sheet S. On the other hand, the foil F2 of the foil layer 251 that is not in contact with the toner image TN is retrieved by the retrieval reel 132 while remaining on the backup layer 252 without being adhered to the sheet S. Consequently, the foil layer 251 is selectively transferred to the sheet S according to the pattern of the toner image TN on the sheet S to form a foil image on the sheet S.

### 1-5. Relationship Between Grammage and Wrinkles of Sheet

When the grammage of the sheet S decreases, the stiffness of the sheet S decreases. As a result, wrinkles are likely to occur in the sheet S. The sheet S passes through a nip portion (contact region) formed by the heating roller 121 and the pressure roller 122. A direction orthogonal to the conveyance direction of the sheet S is referred to as a width direction. The nip length (the length of the contact region in the conveyance direction) at each position in the width direction is not completely equal. A difference occurs in the conveyance speed at each position in the width direction of the sheet S, and stress is applied to the sheet S. In particular, when the stiffness is small, the influence of stress due to the conveyance speed difference is likely to be manifested in the sheet S, and wrinkles are likely to be generated.

On the other hand, if the grammage of the sheet S is too large, the stiffness of the sheet S increases, and a conveyance resistance applied to a conveyance guide increases. As a result, a feeding error or a conveyance error (a conveyance delay, a conveyance failure, a jam, or the like) is likely to occur. Therefore, the grammage of the sheet S needs to be within a range in which wrinkles are less likely to occur and conveyance error is less likely to occur. For example, the grammage is greater than or equal to 90 g/m\hat{ }2 and less than or equal to 350 g/m\hat{ }2. “\hat{ }” is an arithmetic symbol representing a power.

### 1-6. Foil Print Mode

The type of sheet S that can be formed a toner image with the image forming apparatus 100 (e.g. size, thickness, grammage, presence or absence of surface coating, etc.) may not match the type of sheet S that can be subjected to foil processing by the foil printer 120. Therefore, there is a possibility that the foil printer 120 cannot use the sheet S on which images are printed by the image forming apparatus 100 in a normal print mode. Therefore, the image forming apparatus 100 may be provided with a foil print mode for forming a toner image on the sheet S that can be subjected to foil processing by the foil printer 120.

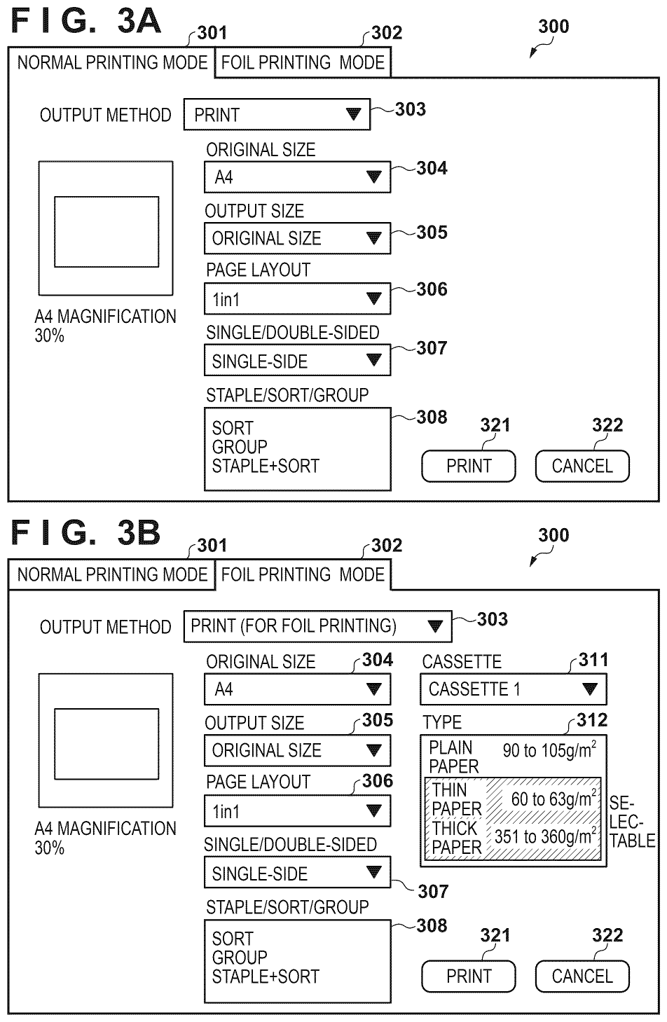

FIG. 3A and FIG. 3B are diagrams illustrating a user interface (UI) 300 for instructing the image forming apparatus 100 to execute a print job from the operation unit 40 or PC. A tab 301 is a setting screen for the normal print mode. A tab 302 is a setting screen for the foil print mode. In FIG. 3A, the normal print mode is selected. In FIG. 3B, the foil print mode is selected. Thus, the tab 301 and the tab 302 function as a mode selection, designation, or switching unit.

A menu 303 is a menu for designating an image output method (e.g. printing, transmitting, and storing). A menu 304 is a menu for selecting an original size. A menu 305 is a menu for selecting an output size of an image for the sheet S. A menu 306 is a menu for selecting a page layout (e.g. 1in1, 2in1). A menu 307 is a menu for selecting a single-side printing or a double-side printing. A setting unit 308 is a UI for selecting the presence or absence of stapling (using stapler), the presence or absence of grouping, or the presence or absence of sorting. The print button 321 is a button for instructing execution of printing. The cancel button 322 is a button for canceling printing.

As shown in FIG. 3B, the menu 311 is a menu for selecting one cassette 5 to which the sheet S is to be fed from the plurality of cassettes 5. When a plurality of cassettes 5 are present, the type of the sheet S can be changed by switching the cassettes 5. The grammage selection unit 312 displays a list of selection candidates for selecting the type of the sheet S, and accepts selection of one type from a plurality of selection candidates. Here, as the type, the grammage and a general name (e.g. plain paper, thin paper, or thick paper) of the type corresponding to the grammage are displayed. For example, the grammage of a plain paper is greater than or equal to 90 g/m\hat{ }2 and less than or equal to 105 g/m\hat{ }2. For example, the grammage of a thin paper is greater than or equal to 60 g/m\hat{ }2 and less than or equal to 63 g/m\hat{ }2. For example, the grammage of a thick paper is greater than or equal to 350 g/m\hat{ }2 and less than or equal to 360 g/m\hat{ }2. These are just examples.

Incidentally, in some cases, the foil printer 120 does not recommend foil processing into a thin paper or a thick paper. In this case, the grammage selection unit 312 may highlight an option (e.g., thin paper or thick paper) that is outside the recommended grammage range of the foil printer 120 and prompt the user (operator) to pay attention.

### 1-7. Controller (Control System)

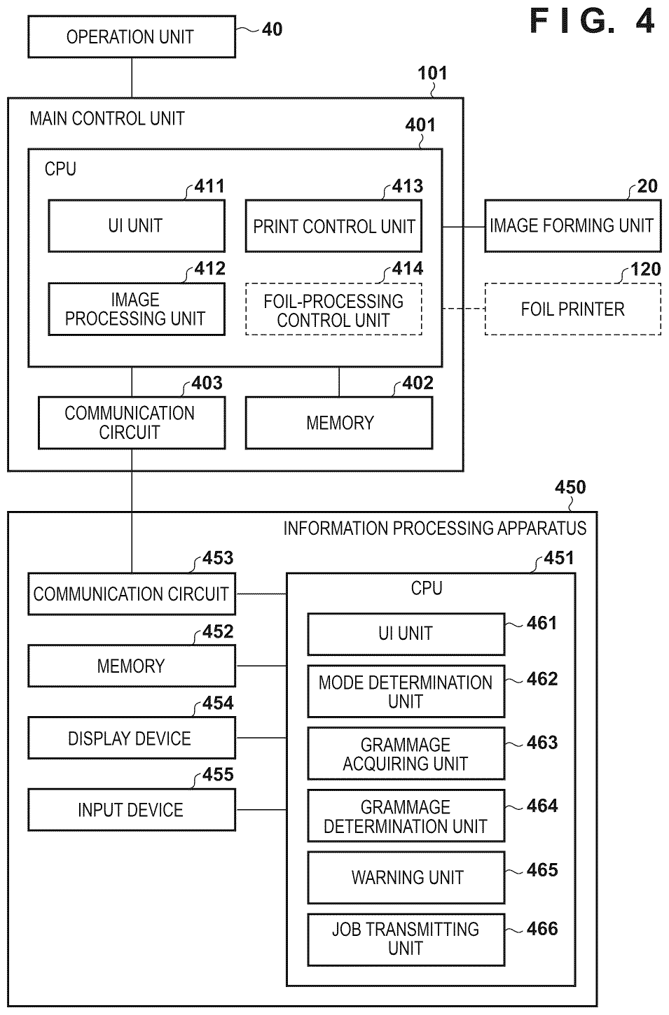

FIG. 4 shows a controller of the image forming system 1. A motor and a power supply other than the load illustrated are connected to the main control unit 101, since they are not the present invention, their illustration and description are omitted.

The main control unit 101 includes, for example, a central processing unit (CPU) 401, a memory 402, and a communication circuit 403. The memory 402 may include a read only memory (ROM), a random access memory (RAM), and the like. The CPU 401 implements various functions by executing a control program stored in a ROM area of the memory 402.

A UI unit 411 displays information on the operation unit 40 and accepts an instruction and information inputted by a user through the operation unit 40. An image processing unit 412 expands print data described by a page description language (PDL) into image data, converts a color space of the image data, and so on. Further, the image processing unit 412 may enlarge or reduce an image or rotate an image.

The print control unit 413 controls the image forming unit 20 according to a print job received from the information processing apparatus 450 via the communication circuit 403 to form a toner image on the sheet S. The foil processing control unit 414 is optional when the image forming apparatus 100 and the foil printer 120 are connectable. The foil processing control unit 414 controls the foil printer 120 according to the print job, and applies foil printing to the sheet S outputted from the image forming apparatus 100. In the present embodiment, the foil printer 120 may be a stand-alone device that is not connected to the image forming apparatus 100 and the information processing apparatus 450.

One or more functions described as being implemented by the CPU 401 may be implemented separately by integrated circuit provided outside of the CPU 401 and capable of communicating with the CPU 401. The communication circuit 403 is an interface circuit used by the CPU 401 to communicate with the foil printer 120 and the information processing apparatus 450.

The image forming apparatus 100 may optionally communicate with the information processing apparatus 450. A CPU 451 of the information processing apparatus 450 executes an operating system (OS) and printer drivers stored in a memory 452 and controls the image forming apparatus 100. The CPU 451 communicates with the image forming apparatus 100 through a communication circuit 453. The memory 452 is a storage device that may include a hard disk drive, a solid state drive (SSD), or the like in addition to ROM, and RAM. A display device 454 is a liquid crystal display or the like that displays a user interface (UI) or the like of the printer driver. An input device 455 may include a keyboard, a pointing device, a touch sensor, a microphone, and the like.

The CPU 451 includes a UI unit 461, a mode determination unit 462, a grammage acquiring unit 463, a grammage determination unit 464, a warning unit 465, and a job transmitting unit 466. The mode determination unit 462 determines which of a foil print mode in which a toner image (glue image) for foil printing is formed on the sheet S and a normal print mode in which a normal toner image that is not for foil printing is formed is designated by the user. The UI unit 461 displays a setting screen on the display device 454. The selection of the mode may be performed in advance through the setting screen. The grammage acquiring unit 463 acquires the grammage of the sheet S selected or designated by the user through the setting screen displayed on the display device 454 by the UI unit 461. The grammage acquiring unit 463 acquires the range of the grammage recommended by image forming apparatus 100 (recommended grammage range) from the image forming apparatus 100, or acquires the recommended grammage range by the foil printer 120 from the foil printer 120. The recommended grammage range may be acquired via a communication circuit 453 from a Web page introducing the image forming apparatus 100 or a Web page introducing the foil printer 120. Alternatively, a recommended grammage range may be acquired from the memory 452. When the foil print mode is selected, the grammage determination unit 464 determines whether the user-designated grammage is within the recommended grammage range of the image forming apparatus 100 and within the recommended grammage range of the foil printer 120. The intersection of the recommended grammage range of the image forming apparatus 100 and the recommended grammage range of the foil printer 120 may be referred to as a common recommended grammage range or an appropriate range. In this case, the grammage determination unit 464 may determine whether the grammage designated by the user is outside the appropriate range. The warning unit 465 outputs warning information through the display device 454 or the operation unit 40 when the grammage designated by the user is outside the appropriate range. The job transmitting unit 466 creates a print job by reflecting the print mode and the grammage designated by the user, and transmits the print job to the image forming apparatus 100 through the communication circuit 453. The print job is control data that may include information about a print mode, information about a grammage, image data, and the like.

### 1-8. Control Method

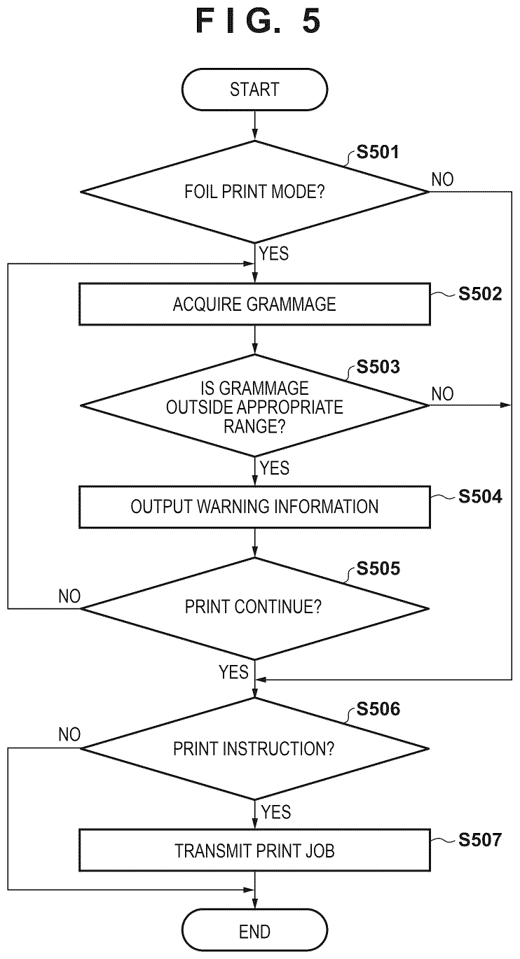

FIG. 5 shows a control method executed by the CPU 451 of the information processing apparatus 450. The CPU 451 executes the following process by executing the printer driver program.

In the step S501, the CPU 451 (mode determination unit 462) determines whether the print mode selected by the user is the foil print mode. If the selected print mode is not a foil print mode, the image forming apparatus 100 is capable of forming a toner image on the sheet S of designated grammage within the recommended grammage range of the image forming apparatus 100. Therefore, the CPU 451 proceeds from the step S501 to the step S506. If the selected print mode is a foil print mode, it is recommended that the designated grammage be within an appropriate range. Therefore, the CPU 451 proceeds from the step S501 to the step S502.

In the step S502, the CPU 451 (grammage acquiring unit 463) acquires the grammage selected by the user. The grammage selected by the user may be acquired in real time through an input screen displayed on the display device 454 and the input device 455. Alternatively, the grammage previously input through the input device 455 and stored in the memory 452 may be read out. Alternatively, the grammage acquiring unit 463 may communicate with the image forming apparatus 100 through the communication circuit 453 to acquire the grammage of the sheet S set in the image forming apparatus 100. This is because the user-definable grammage is the grammage of the sheet S accommodated in the cassette 5 of the image forming apparatus 100.

In the step S503, the CPU 451 (grammage determination unit 464) determines whether the grammage designated by the user is outside the appropriate range. If the grammage designated by the user is within the appropriate range, the CPU 451 processes from the step S503 to the step S506. If the grammage designated by the user is outside the appropriate range, the CPU 451 processes from the step S503 to the step S504.

In the step S504, the CPU 451 (warning unit 465) outputs the warning information to the display device 454 or the operation unit 40. The warning information may be visual information, acoustic information, or a combination thereof.

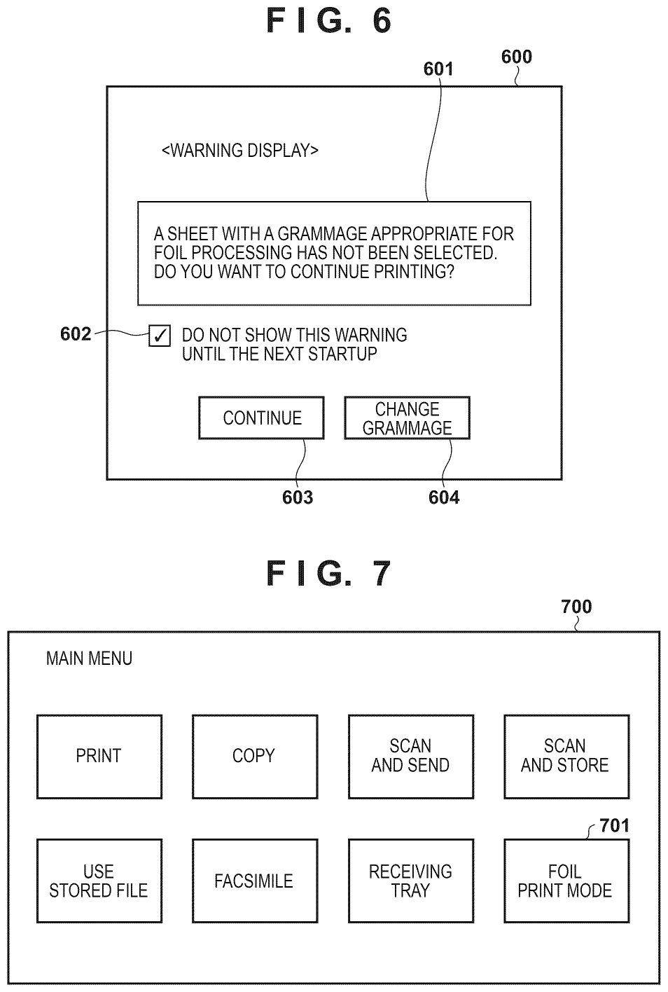

FIG. 6 illustrates an example of the warning UI 600 for outputting warning information. A warning message 601 includes a query that the grammage designated by the user is outside the appropriate range and whether to continue printing. A check box 602 is a check box for restricting the display of the warning UI 600 again. A continuation button 603 is a button for instructing to continue forming the toner image with the non recommended grammage. A grammage change button 604 is a button for displaying a UI (e.g., tab 302) for changing the grammage.

In the step S505, the CPU 451 (UI unit 461) determines whether or not a print continuation is instructed by the user. When the print continuation is instructed, the CPU 451 advances the process from the step S505 to the step S506. When the change of the grammage is instructed, the CPU 451 advances the process from the step S505 to the step S502. In the step S502, the grammage is changed by the user.

In the step S506, the CPU 451 (UI unit 461) determines whether or not a print instruction is input by the user. For example, it may be detected whether the print button 321 has been pressed. When the print instruction is input, the CPU 451 advances the process from the step S506 to the step S507. On the other hand, when the cancel button 322 is pressed, the CPU 451 cancels the print.

In the step S507, the CPU 451 (job transmitting unit 466) creates a print job and transmits the print job to the image forming apparatus 100. For example, a print job in a normal print mode or a print job in a foil print mode with a predetermined grammage designated is transmitted to the image forming apparatus 100.

In this way, in the first embodiment, when the user designates the grammage outside the appropriate range due to an artificial error in the foil print mode, the warning information is output. As a result, it is difficult for the sheet S outside the appropriate range to be inserted into the foil printer 120, and thus it is difficult to cause a conveyance error or a wrinkle. Consequently, the productivity of the image forming system 1 including the foil printer 120 is improved. Also, wasteful consumption of consumables (e.g., sheet S, foil sheet 150) may be reduced.

### II. Second Embodiment

In the first embodiment, the grammage is determined in the information processing apparatus 450 and the warning information is output, but the grammage may be determined in the image forming apparatus 100 and the warning information may be output. Therefore, in the second embodiment, the latter will be described in detail.

FIG. 7 shows a setting UI 700 displayed on the operation unit 40. The setting UI 700 includes a button 701 for selecting a foil print mode. Note that the same reference numerals are given to those having the same or similar functions as those already described.

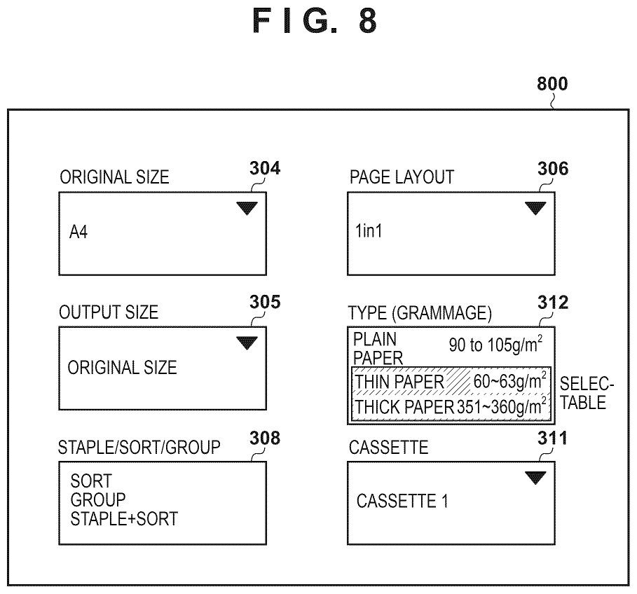

FIG. 8 shows a UI 800 for setting the foil print mode that is displayed on the operation unit 40 when the button 701 is pressed. The grammage selection unit 312 displays a list including a plurality of types (grammages) and allows the user to select any of the grammages. Here, the non recommended grammage (grammage outside the appropriate range) is given a highlight display, but the non recommended grammage is still selectable.

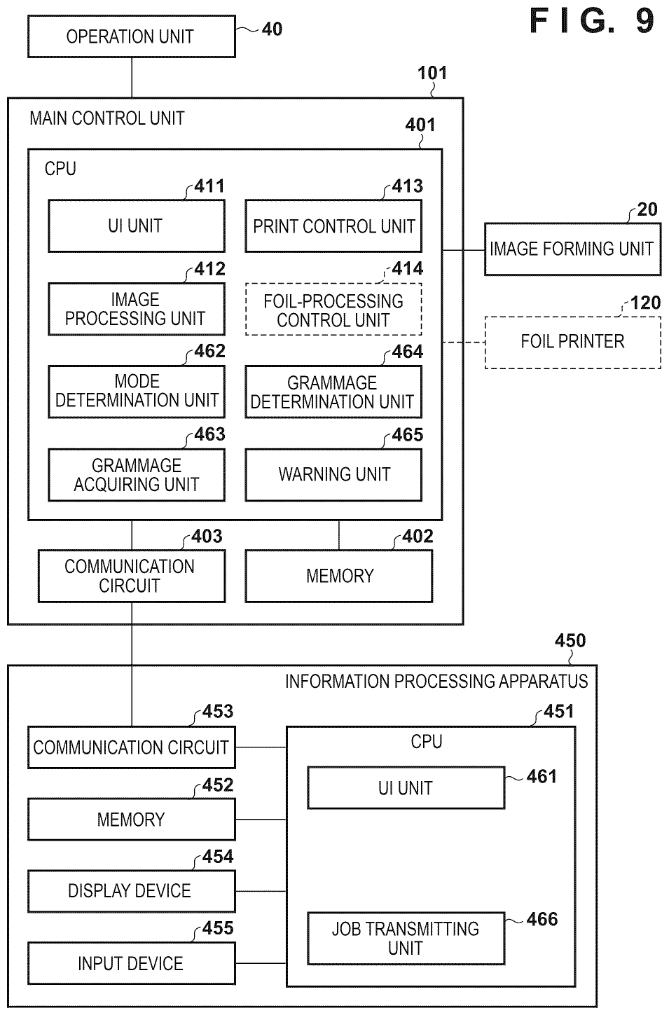

FIG. 9 shows a controller of the image forming system 1. The mode determination unit 462, the grammage acquiring unit 463, the grammage determination unit 464, and the warning unit 465 are described above and implemented by the CPU 401 of the image forming apparatus 100. The job transmitting unit 466 of the information processing apparatus 450 transmits the print job including the print mode and the content of the post-processing to the image forming apparatus 100.

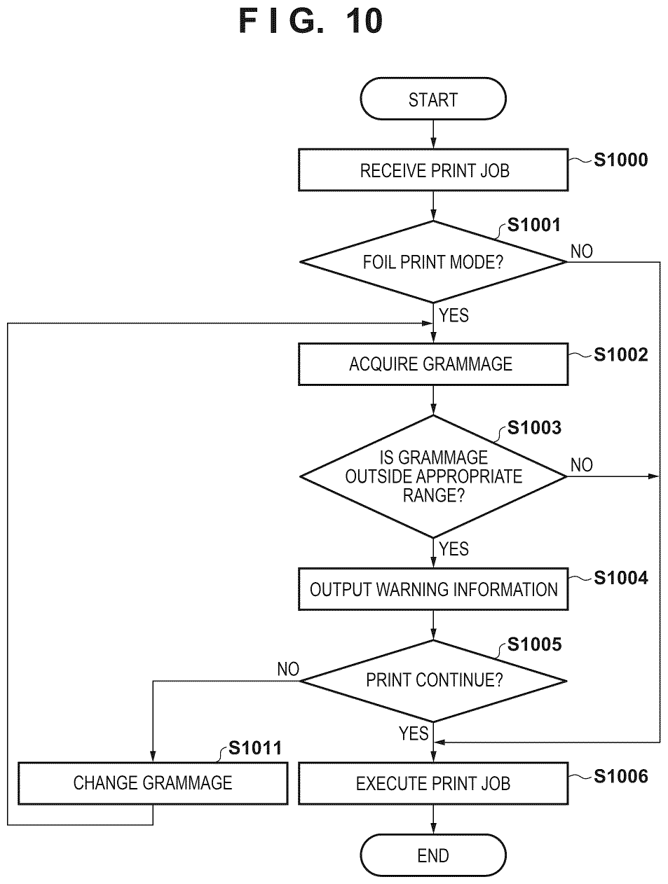

FIG. 10 shows a control method executed by the CPU 401 according to a control program. It is assumed that the control program is stored in the ROM area of the memory 402.

In the step S1000, the CPU 401 receives a print job from the information processing apparatus 450 via the communication circuit 403. Note that, when the image forming apparatus 100 is a copying machine or a multifunction peripheral, a print job (copy job) is issued by the CPU 401 based on an instruction input from the operation unit 40.

In the step S1001, the CPU 401 (mode determination unit 462) analyzes the print job and determines whether the print mode is the foil print mode. Alternatively, when the print mode is not designated in the print job, the mode determination unit 462 determines whether or not the print mode set through the operation unit 40 (e.g., the button 701) is the foil print mode. If the print mode is the foil print mode, the CPU 401 advances the process from the step S1001 to the step S1002. If the print mode is the normal print mode, the CPU 401 advances the process from the step S1001 to the step S1006.

In the step S1002, the CPU 401 (grammage acquiring unit 463) acquires the grammage designated by the user from the print job or the memory 402. The grammage may be selected through the grammage selection unit 312 of the setting UI 800, and the grammage may be stored in the memory 402.

In the step S1003, the CPU 401 (grammage determination unit 464) determines whether the grammage designated by the user is outside the appropriate range. Note that the grammage determination unit 464 may determine a common part between the recommended grammage range of the image forming apparatus 100 and the recommended grammage range of the foil printer 120 as an appropriate range. Alternatively, the grammage determination unit 464 may determine the recommended grammage range of the foil printer 120 as an appropriate range. If the acquired grammage is outside the appropriate range, the CPU 401 advances the process from the step S1003 to the step S1004. If the acquired grammage is within the appropriate range, the CPU 401 advances the process from the step S1003 to the step S1006.

In the step S1004, the CPU 401 (warning unit 465) outputs warning information to the operation unit 40 or the display device 454 of the information processing apparatus 450. For example, the warning unit 465 may display the warning UI 600 on the operation unit 40 or the display device 454.

In the step S1005, the CPU 401 (UI unit 461) determines whether or not a print continuation is instructed by the user. If the continuation button 603 is pressed, the CPU 401 advances the process from the step S1005 to the step S1006. When the grammage change button 604 is pressed, the CPU 401 advances the process from the step S1005 to the step S1011 to acquire the changed grammage from the user.

In the step S1006, the CPU 401 (print control unit 413) executes the print job. If the foil print mode is designated in the print job, the print control unit 413 controls the image forming unit 20 to form a glue image on the sheet S according to the print job. On the other hand, if the normal print mode is designated in the print job, the print control unit 413 controls the image forming unit 20 to form a toner image (normal image) on the sheet S according to the print job.

In this way, in the second embodiment, when the user designates the grammage outside the appropriate range due to an artificial error in the foil print mode, the warning information is output. Accordingly, it is difficult for the sheet S outside the appropriate range to be inserted into the foil printer 120, and it is difficult to cause a conveyance error or a wrinkle. As a result, the productivity of the image forming system 1 including the foil printer 120 is improved. Also, wasteful consumption of consumables (e.g., sheet S, foil sheet 150) may be reduced.

### III. Third Embodiment

In the first embodiment and the second embodiment, the user is allowed to designate the grammage outside the appropriate range even in the foil print mode. These are just examples. For example, if a foil print mode is selected by the user, a UI may be provided that does not allow selection of a grammage outside of the appropriate range.

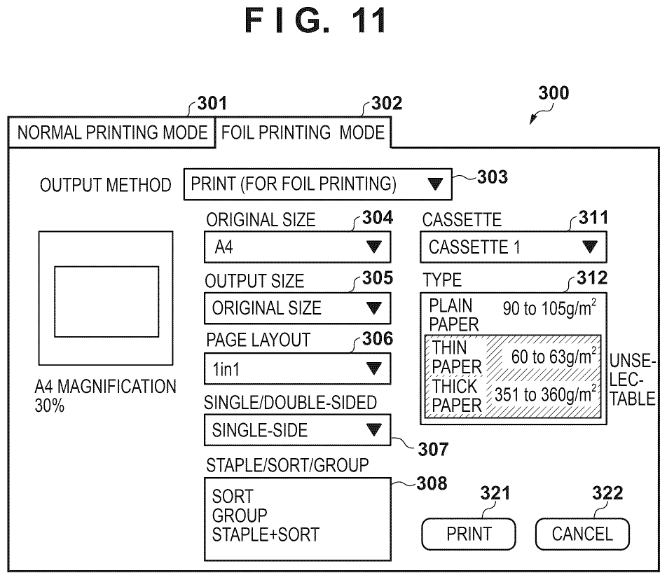

FIG. 11 shows a tab 302 for the foil print mode. In the foil print mode, the selection of a grammage outside the appropriate range should be restricted. Therefore, the CPU 451 grays out a predetermined grammage in the grammage selection unit 312. This makes it impossible to select a grammage outside the appropriate range. It should be noted that the CPU 451 may remove grammages outside the appropriate range from the plurality of listed options. As a result, the grammage outside the appropriate range is not displayed on the grammage selection unit 312, so that the user cannot select the grammage outside the appropriate range. Note that, the CPU 451 displays the grammage outside the appropriate range in the grammage selection unit 312, but may ignore the selection of the grammage outside the appropriate range by the user.

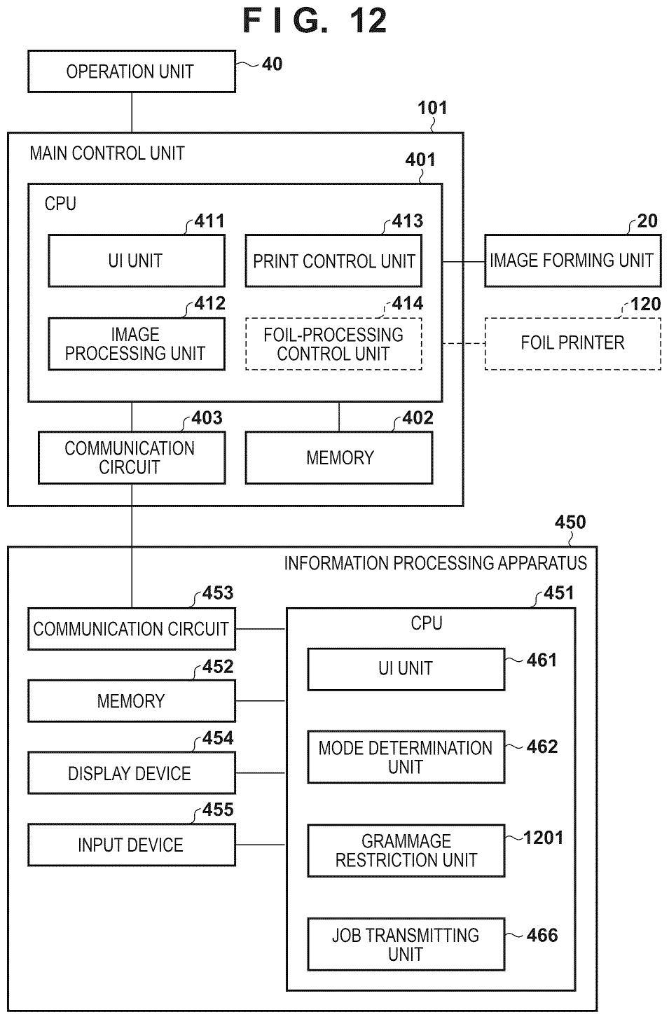

FIG. 12 shows a controller of the image forming system 1. Here, the CPU 451 includes the grammage restriction unit 1201 in addition to the UI unit 461, the mode determination unit 462, and the job transmitting unit 466 described above. When the mode determination unit 462 detects the selection of the foil print mode, the grammage restriction unit 1201 restricts or prohibits the selection of the grammage outside the appropriate range in a UI displayed on the display device 454 by the UI unit 461.

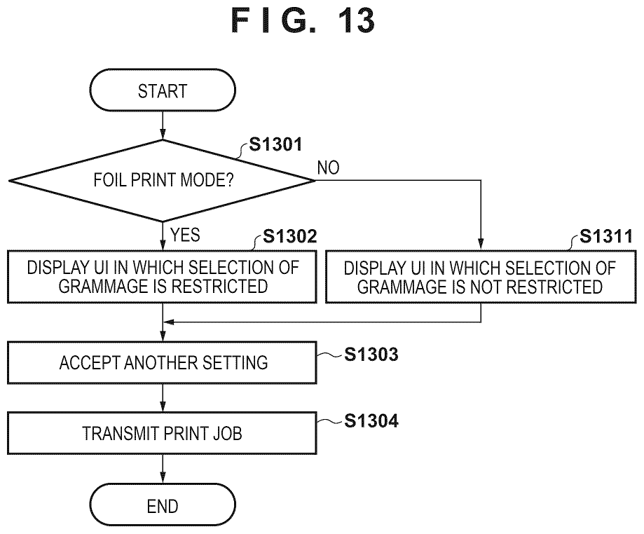

FIG. 13 shows a control method executed by the CPU 451 of the information processing apparatus 450. The CPU 451 executes the following processes according to the printer driver program stored in the memory 452.

In the step S1301, the CPU 451 (mode determination unit 462) determines whether the foil print mode is selected as the print mode. If the foil print mode is selected, the CPU 451 advances the process from the step S1301 to the step S1302.

In the step S1302, the CPU 451 (grammage restriction unit 1201 and UI unit 461) displays, on the display device 454, a UI in which the selection of the grammage outside the appropriate range is restricted.

In the step S1303, the CPU 451 (UI unit 461) accepts another setting (e.g. single-side printing, double-side printing, or number of sheets to be printed).

In the step S1304, the CPU 451 (job transmitting unit 466) transmits a print job to the image forming apparatus 100. When the print mode is a foil print mode, in principle, a grammage outside the appropriate range is not selectable. Therefore, when the print mode is the foil print mode, a print job in which the grammage outside the appropriate range is not applied is created.

The normal print mode may be selected in the step S1301. In this case, the CPU 451 advances the process from the step S1301 to the step S1311.

In the step S1311, the CPU 451 (grammage restriction unit 1201, UI unit 461) displays a UI in which a grammage outside the recommended grammage range based on a specification of the foil printer 120 is no restricted on the display device 454. That is, the user can select the grammage that is within the recommended grammage range of the image forming apparatus 100, even if the grammage is outside the recommended grammage range of the foil printer 120.

The grammage outside the recommended grammage range of the image forming apparatus 100 may still be restricted in selection. After that, the CPU 451 advances the process from the step S1303 to the step S1304.

As described above, in the present embodiment, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### IV Fourth Embodiment

In the fourth embodiment, a case is described in which a selection of a foil print mode and a selection of a grammage can be performed in the image forming apparatus 100. Thus, restricting the selection of the grammage is also performed in the image forming apparatus 100.

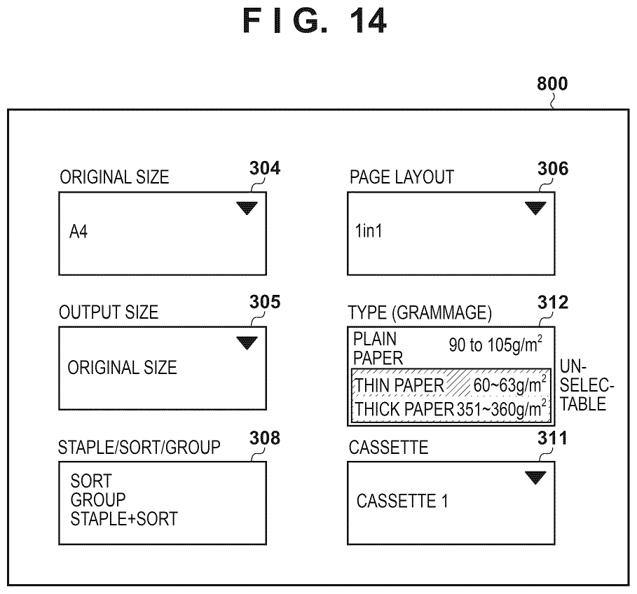

FIG. 14 shows a UI 800 for setting the foil print mode that is displayed on the operation unit 40 when the button 701 is pressed. The grammage selection unit 312 displays a list including a plurality of types (grammage) and allows the user to select any of the grammages. Here, a selection of a grammage outside the appropriate range is restricted. Note that, when the normal print mode is selected, the grammage selection unit 312 displays, on the operation unit 40, the setting UI 800 that does not restrict the selection of the grammage outside the appropriate range.

In FIG. 14, the gray out restricts the selection of the grammage outside the appropriate range. These are just examples. The grammage selection unit 312 may remove grammages outside the appropriate range from a plurality of listed options. Accordingly, the grammage outside the appropriate range is not displayed on the grammage selection unit 312, so that the user cannot select the grammage outside the appropriate range. The CPU 401 displays the grammage outside the appropriate range in the grammage selection unit 312, but may ignore the selection of the grammage outside the appropriate range by the user.

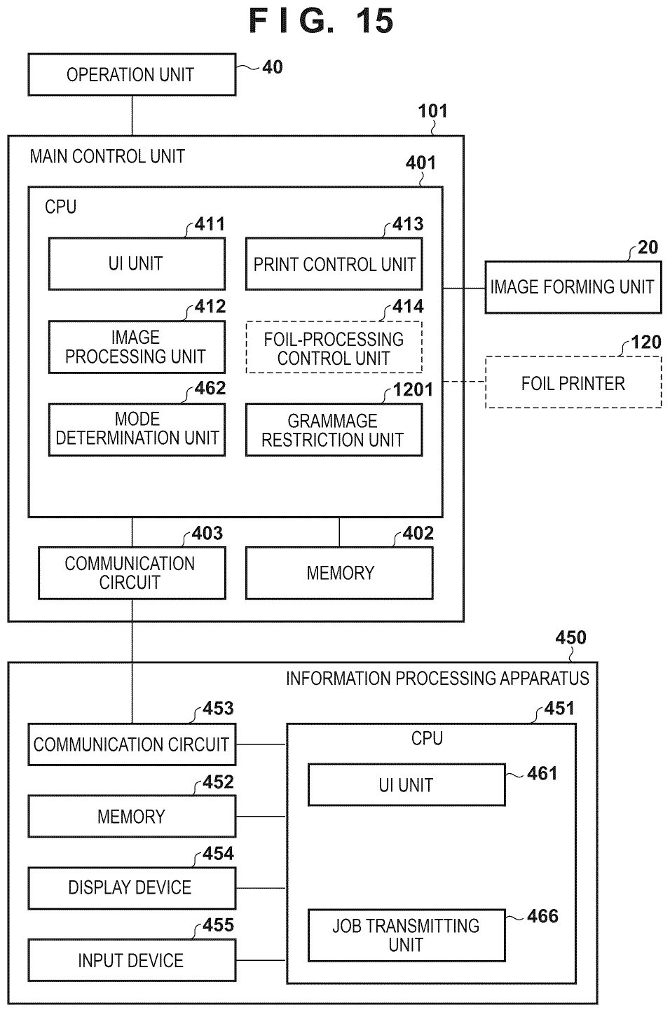

FIG. 15 shows a controller of the image forming system 1. The mode determination unit 462 and the grammage restriction unit 1201 are implemented by the CPU 401. The mode determination unit 462 analyzes the print job to determine whether or not the print mode is set to the foil print mode. Alternatively, the mode determination unit 462 determines whether or not the print mode is set to the foil print mode based on an instruction input through the operation unit 40. When the foil print mode is selected, the grammage restriction unit 1201 restricts the selection of the grammage outside the appropriate range in UI displayed on the operation unit 40.

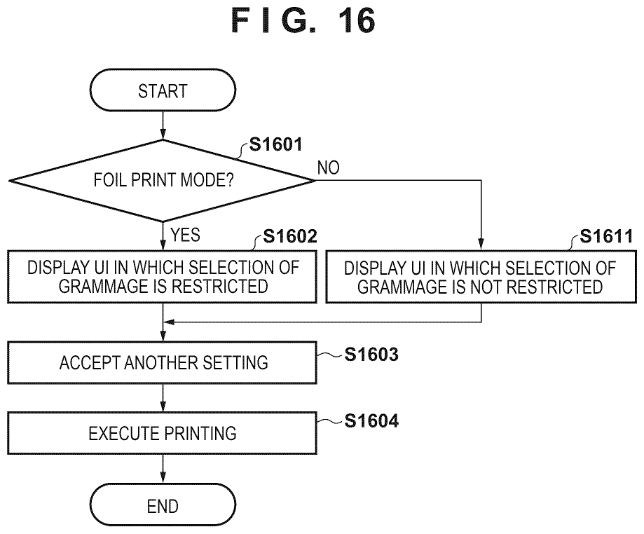

FIG. 16 shows a control method executed by the CPU 401 of the image forming apparatus 100.

In the step S1601, the CPU 401 (mode determination unit 462) determines whether the foil print mode is selected as the print mode. If the foil print mode is selected, the CPU 401 advances the process from the step S1601 to the step S1602.

In the step S1602, the CPU 401 (grammage restriction unit 1201 and UI unit 411) displays, on the operation unit 40, a UI in which the selection of the grammage outside the appropriate range is restricted.

In the step S1603, the CPU 401 (UI unit 411) accepts another setting (e.g. single-side printing, double-side printing, or number of sheets to be printed).

In the step S1604, the CPU 401 (print control unit 413) executes printing according to the print job. When the print mode is the foil print mode, in principle, a grammage outside the appropriate range is not selectable. Therefore, when the print mode is the foil print mode, the grammage outside the appropriate range is not applied.

The normal print mode may be selected in the step S1601. In this case, the CPU 401 advances the process from the step S1601 to the step S1611.

In the step S1611, the CPU 401 (grammage restriction unit 1201 and UI unit 411) displays, on the operation unit 40, a UI in which the selection of the grammage outside the appropriate range is not restricted. That is, the user can select a grammage outside the appropriate range through this UI. As described above, he grammage outside the recommended grammage range of the image forming apparatus 100 may still be restricted in selection. After that, the CPU 401 advances the process from the step S1603 to the step S1604.

As described above, in the present embodiment, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### V. Fifth Embodiment

In the first to fourth embodiments, the foil printer 120 was separated from the image forming apparatus 100. However, the foil printer 120 may be coupled (connected) to the image forming apparatus 100.

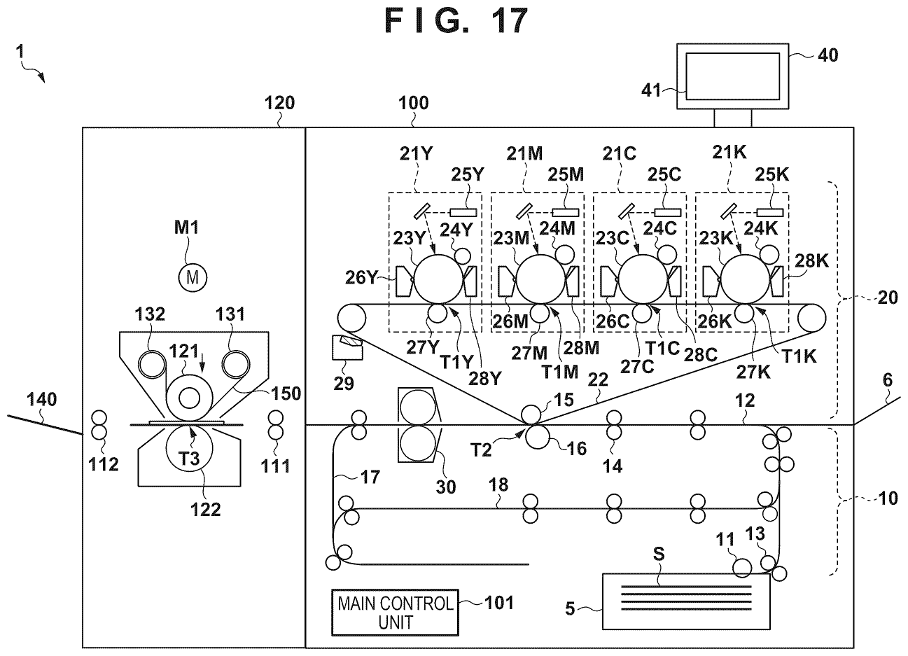

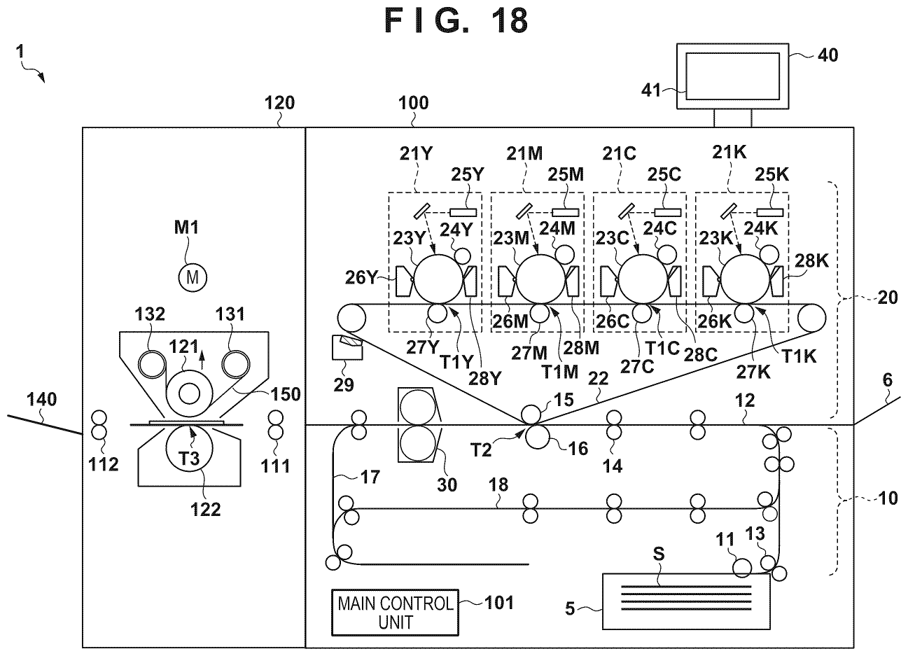

FIG. 17 and FIG. 18 show an image forming system 1 including a foil printer 120 and an image forming apparatus 100 connected to each other. FIG. 17 shows that the heating roller 121 and the pressure roller 122 are in a contact state (in a foil processing state). FIG. 18 shows that the heating roller 121 and the pressure roller 122 are in a separation state (state in which foil processing is not executed). That is, the contact state is adopted in the foil print mode. The separation state is adopted in the normal print mode. The motor M1 is a motor for switching between the contact state and the separation state.

The foil processing control unit 414 controls the foil printer 120. When accepting a print job from the information processing apparatus 450, the image forming apparatus 100 forms a toner image in an area to which foil processing is applied on the sheet S, and conveys the sheet S to the foil printer 120 by the conveyance unit 10.

The CPU 401 (foil processing control unit 414) controls the motor M1 to shift the heating roller 121 and the pressure roller 122 from the separation state to the contact state. The foil printer 120 transfers the foil to the toner image on the sheet S by hot pressing and discharges the sheet S to the discharge tray 140. Thus, a foil image is formed on the sheet S. When the foil processing is completed, the CPU 401 (foil processing control unit 414) controls the motor M1 to shift the heating roller 121 and the pressure roller 122 from the contact state to the separation state. This restricts or prohibits the foil processing to the sheet S that does not require the foil processing.

Even when the foil printer 120 and the image forming apparatus 100 are connected in this manner, the inventions described in the first to fourth embodiments can be applied. As a result, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### VI. Supplement

The image forming unit 20 is an example of an image forming unit that is provided in the image forming apparatus 100 and forms a toner image on the sheet S as an adhesive. The CPUs 401, 451 are examples of a control unit that controls the image forming unit. The CPUs 401, 451, the operation unit 40, and the input device 455 function as an accepting unit that accepts information about the grammage of the sheet. When a predetermined print mode is selected, the operation unit 40 and the display device 454 display a warning according to the information on the grammage of the sheet. This reduces the possibility that a defect occurs in the adhesion of the foil according to the grammage of the sheet.

The grammage of the sheet S on which the toner image is formed by the image forming apparatus 100 as an adhesive may be a grammage that is not recommended in the image forming system 1 (especially the image forming apparatus 100 or the foil printer 120). In this case, the CPUs 401, 451 suppress the print of the toner image on the sheet. Accordingly, the occurrence of conveyance error or wrinkling of the sheet S in the foil printer 120 is reduced, and the productivity in the foil printer 120 is improved. A grammage that is not recommended is a grammage that is outside the appropriate range and may be referred to as a non recommended grammage. A grammage that is recommended may be referred to as a grammage within an appropriate range.

The warning unit 465, the operation unit 40, and the display device 454 display a warning when the accepted grammage is not recommended grammage. In this way, the warning information may be output so that the user may know the grammage that is not recommended in the foil printer 120 and may refrain from selecting such grammage.

The acquired grammage may be a grammage (a non recommended grammage) that is not recommended in the foil printer 120. In this case, the CPUs 401, 451, the operation unit 40, the input device 455, and the warning UI 600 function as an accepting unit that accepts input of instruction information related to whether or not to continue forming a toner image on the sheet S by the image forming apparatus 100. Since the grammage of the sheet S varies widely, there may be a case where even a sheet S having a non recommended grammage does not cause conveyance error and wrinkles in the foil printer 120. Users may have known such sheet S through their experience. By allowing such a user to continue printing, usability is improved.

As described with reference to FIG. 6, the image forming apparatus 100 may continue forming the toner image on the sheet S having a grammage outside the recommended grammage range when the instruction information indicating that the formation of the toner image on the sheet S is continued is input.

As illustrated in FIG. 6, the grammage change button 604 is an example of an accepting unit that accepts input of instruction information regarding whether to change the grammage of the sheet S when the acquired grammage is a non recommended grammage. Accordingly, the grammage of the sheet S is changed from the recommended grammage to the recommended grammage, so that a defect in the foil processing is unlikely to occur.

As illustrated in FIG. 3B and FIG. 5, the operation unit 40 and the display device 454 may display a screen (e.g. UI 300, setting UI 800) for changing or resetting the grammage of the sheet S when instruction information indicating that the grammage of the sheet S is to be changed is input.

The grammage acquiring unit 463 may acquire the grammage of the sheet S on which the toner image is formed as an adhesive by the image forming apparatus 100 through a screen (e.g. UI 300, setting UI 800) for setting the grammage of the sheet S.

As illustrated in FIG. 3B and FIG. 8, the screen may visually distinguish between a grammage that is not recommended in the image forming apparatus 100 or the foil printer 120 and a grammage that is recommended in the image forming apparatus 100 and the foil printer 120. This will allow the user to visually understand the non recommended grammage and the recommended grammage.

The non recommended grammage may be, for example, the grammage causing a conveyance error in the image forming system 1 or the grammage causing wrinkles in the sheet S in the image forming system 1.

In the image forming system 1, the recommended grammage may be greater than or equal to 90 g/m\hat{ }2 and less than or equal to 350 g/m\hat{ }2. The grammage not recommended in the image forming system 1 may be a grammage outside the recommended grammage range (e.g. a grammage less than 90 g/m\hat{ }2 or greater than 350 g/m\hat{ }2). These values are just examples. The recommended grammage range is set according to the specification of the image forming apparatus 100 and the specification of the foil printer 120.

The grammage that is not recommended in the image forming system 1 may be a grammage that is not recommended in the foil printer 120. This will reduce the occurrence of conveyance error and wrinkles in the foil printer 120.

The grammage not recommended in the image forming system 1 may be a union of the grammage range not recommended in the foil printer 120 and the grammage range not recommended in the image forming apparatus 100. This will reduce the occurrence of conveyance errors and wrinkles in the image forming apparatus 100 and reduce the occurrence of conveyance errors and wrinkles in the foil printer 120. Note that, the appropriate range in the image forming system 1 may be a common part (intersection) of the recommended grammage range of the foil printer 120 and the recommended grammage range of the image forming apparatus 100.

As illustrated in FIG. 3B, FIG. 8, FIG. 11, and FIG. 14, the tab 302 and the setting UI 800 are examples of an accepting unit that accepts input of the grammage of the sheet S on which the toner image is formed. The CPUs 401, 451 may restrict input of the non recommended grammage through the accepting unit.

As illustrated in FIG. 11 and FIG. 14, the tab 302 and the setting UI 800 are examples of screens for accepting input of grammage information (e.g. plain paper, 90 g/m\hat{ }2 to 105 g/m\hat{ }2) indicating the grammage of the sheet on which the toner image is formed. The tab 302 and the setting UI 800 may not display the non recommended grammage as selectable candidates (e.g., grayed out), and may display the recommended grammage as selectable candidates.

The CPU 401 may control the accepting unit such that, when the predetermined print mode is selected, the sheet of the first grammage is selectable and the sheet of the second grammage differing from the first grammage is not selectable.

The communication circuit 453 functions as a transmitting unit that transmits a job for forming a toner image on the sheet S to the image forming apparatus 100 as an adhesive for adhering the foil to the sheet S in the foil printer 120. The CPU 451 functions as a control unit that controls the image forming apparatus 100 through the communication circuit 453. The CPU 451 may function as a selection unit for selecting a predetermined print mode for forming the toner image for adhering the foil over the sheet via the toner image. The CPU 451 may function as an accepting unit that accepts information about the grammage of the sheet. The CPU 451 may function as a display control unit that, when a predetermined print mode is selected, causes the display unit to display a warning according to the information regarding the grammage of the sheet.

There is a case in which a predetermined print mode is selected when accepting information on the grammage of the sheet. Here, the CPU 451 may act that a sheet of a first grammage is selectable and a sheet of a second grammage that differs from the first grammage is unselectable.

### 1-5. Relationship Between Grammage and Wrinkles of Sheet

When the grammage of the sheet S decreases, the stiffness of the sheet S decreases. As a result, wrinkles are likely to occur in the sheet S. The sheet S passes through a nip portion (contact region) formed by the heating roller 121 and the pressure roller 122. A direction orthogonal to the conveyance direction of the sheet S is referred to as a width direction. The nip length (the length of the contact region in the conveyance direction) at each position in the width direction is not completely equal. A difference occurs in the conveyance speed at each position in the width direction of the sheet S, and stress is applied to the sheet S. In particular, when the stiffness is small, the influence of stress due to the conveyance speed difference is likely to be manifested in the sheet S, and wrinkles are likely to be generated.

On the other hand, if the grammage of the sheet S is too large, the stiffness of the sheet S increases, and a conveyance resistance applied to a conveyance guide increases. As a result, a feeding error or a conveyance error (a conveyance delay, a conveyance failure, a jam, or the like) is likely to occur. Therefore, the grammage of the sheet S needs to be within a range in which wrinkles are less likely to occur and conveyance error is less likely to occur. For example, the grammage is greater than or equal to 90 g/m\hat{ }2 and less than or equal to 350 g/m\hat{ }2. “\hat{ }” is an arithmetic symbol representing a power.

### 1-6. Foil Print Mode

The type of sheet S that can be formed a toner image with the image forming apparatus 100 (e.g. size, thickness, grammage, presence or absence of surface coating, etc.) may not match the type of sheet S that can be subjected to foil processing by the foil printer 120. Therefore, there is a possibility that the foil printer 120 cannot use the sheet S on which images are printed by the image forming apparatus 100 in a normal print mode. Therefore, the image forming apparatus 100 may be provided with a foil print mode for forming a toner image on the sheet S that can be subjected to foil processing by the foil printer 120.

FIG. 3A and FIG. 3B are diagrams illustrating a user interface (UI) 300 for instructing the image forming apparatus 100 to execute a print job from the operation unit 40 or PC. A tab 301 is a setting screen for the normal print mode. A tab 302 is a setting screen for the foil print mode. In FIG. 3A, the normal print mode is selected. In FIG. 3B, the foil print mode is selected. Thus, the tab 301 and the tab 302 function as a mode selection, designation, or switching unit.

A menu 303 is a menu for designating an image output method (e.g. printing, transmitting, and storing). A menu 304 is a menu for selecting an original size. A menu 305 is a menu for selecting an output size of an image for the sheet S. A menu 306 is a menu for selecting a page layout (e.g. 1in1, 2in1). A menu 307 is a menu for selecting a single-side printing or a double-side printing. A setting unit 308 is a UI for selecting the presence or absence of stapling (using stapler), the presence or absence of grouping, or the presence or absence of sorting. The print button 321 is a button for instructing execution of printing. The cancel button 322 is a button for canceling printing.

As shown in FIG. 3B, the menu 311 is a menu for selecting one cassette 5 to which the sheet S is to be fed from the plurality of cassettes 5. When a plurality of cassettes 5 are present, the type of the sheet S can be changed by switching the cassettes 5. The grammage selection unit 312 displays a list of selection candidates for selecting the type of the sheet S, and accepts selection of one type from a plurality of selection candidates. Here, as the type, the grammage and a general name (e.g. plain paper, thin paper, or thick paper) of the type corresponding to the grammage are displayed. For example, the grammage of a plain paper is greater than or equal to 90 g/m\hat{ }2 and less than or equal to 105 g/m\hat{ }2. For example, the grammage of a thin paper is greater than or equal to 60 g/m\hat{ }2 and less than or equal to 63 g/m\hat{ }2. For example, the grammage of a thick paper is greater than or equal to 350 g/m\hat{ }2 and less than or equal to 360 g/m\hat{ }2. These are just examples.

Incidentally, in some cases, the foil printer 120 does not recommend foil processing into a thin paper or a thick paper. In this case, the grammage selection unit 312 may highlight an option (e.g., thin paper or thick paper) that is outside the recommended grammage range of the foil printer 120 and prompt the user (operator) to pay attention.

### 1-7. Controller (Control System)

FIG. 4 shows a controller of the image forming system 1. A motor and a power supply other than the load illustrated are connected to the main control unit 101, since they are not the present invention, their illustration and description are omitted.

The main control unit 101 includes, for example, a central processing unit (CPU) 401, a memory 402, and a communication circuit 403. The memory 402 may include a read only memory (ROM), a random access memory (RAM), and the like. The CPU 401 implements various functions by executing a control program stored in a ROM area of the memory 402.

A UI unit 411 displays information on the operation unit 40 and accepts an instruction and information inputted by a user through the operation unit 40. An image processing unit 412 expands print data described by a page description language (PDL) into image data, converts a color space of the image data, and so on. Further, the image processing unit 412 may enlarge or reduce an image or rotate an image.

The print control unit 413 controls the image forming unit 20 according to a print job received from the information processing apparatus 450 via the communication circuit 403 to form a toner image on the sheet S. The foil processing control unit 414 is optional when the image forming apparatus 100 and the foil printer 120 are connectable. The foil processing control unit 414 controls the foil printer 120 according to the print job, and applies foil printing to the sheet S outputted from the image forming apparatus 100. In the present embodiment, the foil printer 120 may be a stand-alone device that is not connected to the image forming apparatus 100 and the information processing apparatus 450.

One or more functions described as being implemented by the CPU 401 may be implemented separately by integrated circuit provided outside of the CPU 401 and capable of communicating with the CPU 401. The communication circuit 403 is an interface circuit used by the CPU 401 to communicate with the foil printer 120 and the information processing apparatus 450.

The image forming apparatus 100 may optionally communicate with the information processing apparatus 450. A CPU 451 of the information processing apparatus 450 executes an operating system (OS) and printer drivers stored in a memory 452 and controls the image forming apparatus 100. The CPU 451 communicates with the image forming apparatus 100 through a communication circuit 453. The memory 452 is a storage device that may include a hard disk drive, a solid state drive (SSD), or the like in addition to ROM, and RAM. A display device 454 is a liquid crystal display or the like that displays a user interface (UI) or the like of the printer driver. An input device 455 may include a keyboard, a pointing device, a touch sensor, a microphone, and the like.

The CPU 451 includes a UI unit 461, a mode determination unit 462, a grammage acquiring unit 463, a grammage determination unit 464, a warning unit 465, and a job transmitting unit 466. The mode determination unit 462 determines which of a foil print mode in which a toner image (glue image) for foil printing is formed on the sheet S and a normal print mode in which a normal toner image that is not for foil printing is formed is designated by the user. The UI unit 461 displays a setting screen on the display device 454. The selection of the mode may be performed in advance through the setting screen. The grammage acquiring unit 463 acquires the grammage of the sheet S selected or designated by the user through the setting screen displayed on the display device 454 by the UI unit 461. The grammage acquiring unit 463 acquires the range of the grammage recommended by image forming apparatus 100 (recommended grammage range) from the image forming apparatus 100, or acquires the recommended grammage range by the foil printer 120 from the foil printer 120. The recommended grammage range may be acquired via a communication circuit 453 from a Web page introducing the image forming apparatus 100 or a Web page introducing the foil printer 120. Alternatively, a recommended grammage range may be acquired from the memory 452. When the foil print mode is selected, the grammage determination unit 464 determines whether the user-designated grammage is within the recommended grammage range of the image forming apparatus 100 and within the recommended grammage range of the foil printer 120. The intersection of the recommended grammage range of the image forming apparatus 100 and the recommended grammage range of the foil printer 120 may be referred to as a common recommended grammage range or an appropriate range. In this case, the grammage determination unit 464 may determine whether the grammage designated by the user is outside the appropriate range. The warning unit 465 outputs warning information through the display device 454 or the operation unit 40 when the grammage designated by the user is outside the appropriate range. The job transmitting unit 466 creates a print job by reflecting the print mode and the grammage designated by the user, and transmits the print job to the image forming apparatus 100 through the communication circuit 453. The print job is control data that may include information about a print mode, information about a grammage, image data, and the like.

### 1-8. Control Method

FIG. 5 shows a control method executed by the CPU 451 of the information processing apparatus 450. The CPU 451 executes the following process by executing the printer driver program.

In the step S501, the CPU 451 (mode determination unit 462) determines whether the print mode selected by the user is the foil print mode. If the selected print mode is not a foil print mode, the image forming apparatus 100 is capable of forming a toner image on the sheet S of designated grammage within the recommended grammage range of the image forming apparatus 100. Therefore, the CPU 451 proceeds from the step S501 to the step S506. If the selected print mode is a foil print mode, it is recommended that the designated grammage be within an appropriate range. Therefore, the CPU 451 proceeds from the step S501 to the step S506.

In the step S502, the CPU 451 (grammage acquiring unit 463) acquires the grammage selected by the user. The grammage selected by the user may be acquired in real time through an input screen displayed on the display device 454 and the input device 455. Alternatively, the grammage previously input through the input device 455 and stored in the memory 452 may be read out. Alternatively, the grammage acquiring unit 463 may communicate with the image forming apparatus 100 through the communication circuit 453 to acquire the grammage of the sheet S set in the image forming apparatus 100. This is because the user-definable grammage is the grammage of the sheet S accommodated in the cassette 5 of the image forming apparatus 100.

In the step S503, the CPU 451 (grammage determination unit 464) determines whether the grammage designated by the user is outside the appropriate range. If the grammage designated by the user is within the appropriate range, the CPU 451 processes from the step S503 to the step S506. If the grammage designated by the user is outside the appropriate range, the CPU 451 processes from the step S503 to the step S504.

In the step S504, the CPU 451 (warning unit 465) outputs the warning information to the display device 454 or the operation unit 40. The warning information may be visual information, acoustic information, or a combination thereof.

FIG. 6 illustrates an example of the warning UI 600 for outputting warning information. A warning message 601 includes a query that the grammage designated by the user is outside the appropriate range and whether to continue printing. A check box 602 is a check box for restricting the display of the warning UI 600 again. A continuation button 603 is a button for instructing to continue forming the toner image with the non recommended grammage. A grammage change button 604 is a button for displaying a UI (e.g., tab 302) for changing the grammage.

In the step S505, the CPU 451 (UI unit 461) determines whether or not a print continuation is instructed by the user. When the print continuation is instructed, the CPU 451 advances the process from the step S505 to the step S506. When the change of the grammage is instructed, the CPU 451 advances the process from the step S505 to the step S506. In the step S502, the grammage is changed by the user.

In the step S506, the CPU 451 (UI unit 461) determines whether or not a print instruction is input by the user. For example, it may be detected whether the print button 321 has been pressed. When the print instruction is input, the CPU 451 advances the process from the step S506 to the step S507. On the other hand, when the cancel button 322 is pressed, the CPU 451 cancels the print.

In the step S507, the CPU 451 (job transmitting unit 466) creates a print job and transmits the print job to the image forming apparatus 100. For example, a print job in a normal print mode or a print job in a foil print mode with a predetermined grammage designated is transmitted to the image forming apparatus 100.

In this way, in the first embodiment, when the user designates the grammage outside the appropriate range due to an artificial error in the foil print mode, the warning information is output. As a result, it is difficult for the sheet S outside the appropriate range to be inserted into the foil printer 120, and thus it is difficult to cause a conveyance error or a wrinkle. Consequently, the productivity of the image forming system 1 including the foil printer 120 is improved. Also, wasteful consumption of consumables (e.g., sheet S, foil sheet 150) may be reduced.

### II. Second Embodiment

In the first embodiment, the grammage is determined in the information processing apparatus 450 and the warning information is output, but the grammage may be determined in the image forming apparatus 100 and the warning information may be output. Therefore, in the second embodiment, the latter will be described in detail.

FIG. 7 shows a setting UI 700 displayed on the operation unit 40. The setting UI 700 includes a button 701 for selecting a foil print mode. Note that the same reference numerals are given to those having the same or similar functions as those already described.

FIG. 8 shows a UI 800 for setting the foil print mode that is displayed on the operation unit 40 when the button 701 is pressed. The grammage selection unit 312 displays a list including a plurality of types (grammages) and allows the user to select any of the grammages. Here, the non recommended grammage (grammage outside the appropriate range) is given a highlight display, but the non recommended grammage is still selectable.

FIG. 9 shows a controller of the image forming system 1. The mode determination unit 462, the grammage acquiring unit 463, the grammage determination unit 464, and the warning unit 465 are described above and implemented by the CPU 401 of the image forming apparatus 100. The job transmitting unit 466 of the information processing apparatus 450 transmits the print job including the print mode and the content of the post-processing to the image forming apparatus 100.

FIG. 10 shows a control method executed by the CPU 401 according to a control program. It is assumed that the control program is stored in the ROM area of the memory 402.

In the step S1000, the CPU 401 receives a print job from the information processing apparatus 450 via the communication circuit 403. Note that, when the image forming apparatus 100 is a copying machine or a multifunction peripheral, a print job (copy job) is issued by the CPU 401 based on an instruction input from the operation unit 40.

In the step S1001, the CPU 401 (mode determination unit 462) analyzes the print job and determines whether the print mode is the foil print mode. Alternatively, when the print mode is not designated in the print job, the mode determination unit 462 determines whether or not the print mode set through the operation unit 40 (e.g., the button 701) is the foil print mode. If the print mode is the foil print mode, the CPU 401 advances the process from the step S1001 to the step S1002. If the print mode is the normal print mode, the CPU 401 advances the process from the step S1001 to the step S1006.

In the step S1002, the CPU 401 (grammage acquiring unit 463) acquires the grammage designated by the user from the print job or the memory 402. The grammage may be selected through the grammage selection unit 312 of the setting UI 800, and the grammage may be stored in the memory 402.

In the step S1003, the CPU 401 (grammage determination unit 464) determines whether the grammage designated by the user is outside the appropriate range. Note that the grammage determination unit 464 may determine a common part between the recommended grammage range of the image forming apparatus 100 and the recommended grammage range of the foil printer 120 as an appropriate range. Alternatively, the grammage determination unit 464 may determine the recommended grammage range of the foil printer 120 as an appropriate range. If the acquired grammage is outside the appropriate range, the CPU 401 advances the process from the step S1003 to the step S1004. If the acquired grammage is within the appropriate range, the CPU 401 advances the process from the step S1003 to the step S1006.

In the step S1004, the CPU 401 (warning unit 465) outputs warning information to the operation unit 40 or the display device 454 of the information processing apparatus 450. For example, the warning unit 465 may display the warning UI 600 on the operation unit 40 or the display device 454.

In the step S1005, the CPU 401 (UI unit 461) determines whether or not a print continuation is instructed by the user. If the continuation button 603 is pressed, the CPU 401 advances the process from the step S1005 to the step S1006. When the grammage change button 604 is pressed, the CPU 401 advances the process from the step S1005 to the step S1011 to acquire the changed grammage from the user.

In the step S1006, the CPU 401 (print control unit 413) executes the print job. If the foil print mode is designated in the print job, the print control unit 413 controls the image forming unit 20 to form a glue image on the sheet S according to the print job. On the other hand, if the normal print mode is designated in the print job, the print control unit 413 controls the image forming unit 20 to form a toner image (normal image) on the sheet S according to the print job.

In this way, in the second embodiment, when the user designates the grammage outside the appropriate range due to an artificial error in the foil print mode, the warning information is output. Accordingly, it is difficult for the sheet S outside the appropriate range to be inserted into the foil printer 120, and it is difficult to cause a conveyance error or a wrinkle. As a result, the productivity of the image forming system 1 including the foil printer 120 is improved. Also, wasteful consumption of consumables (e.g., sheet S, foil sheet 150) may be reduced.

### III. Third Embodiment

In the first embodiment and the second embodiment, the user is allowed to designate the grammage outside the appropriate range even in the foil print mode. These are just examples. For example, if a foil print mode is selected by the user, a UI may be provided that does not allow selection of a grammage outside of the appropriate range.

FIG. 11 shows a tab 302 for the foil print mode. In the foil print mode, the selection of a grammage outside the appropriate range should be restricted. Therefore, the CPU 451 grays out a predetermined grammage in the grammage selection unit 312. This makes it impossible to select a grammage outside the appropriate range. It should be noted that the CPU 451 may remove grammages outside the appropriate range from the plurality of listed options. As a result, the grammage outside the appropriate range is not displayed on the grammage selection unit 312, so that the user cannot select the grammage outside the appropriate range. Note that, the CPU 451 displays the grammage outside the appropriate range in the grammage selection unit 312, but may ignore the selection of the grammage outside the appropriate range by the user.

FIG. 12 shows a controller of the image forming system 1. Here, the CPU 451 includes the grammage restriction unit 1201 in addition to the UI unit 461, the mode determination unit 462, and the job transmitting unit 466 described above. When the mode determination unit 462 detects the selection of the foil print mode, the grammage restriction unit 1201 restricts or prohibits the selection of the grammage outside the appropriate range in a UI displayed on the display device 454 by the UI unit 461.

FIG. 13 shows a control method executed by the CPU 451 of the information processing apparatus 450. The CPU 451 executes the following processes according to the printer driver program stored in the memory 452.

In the step S1301, the CPU 451 (mode determination unit 462) determines whether the foil print mode is selected as the print mode. If the foil print mode is selected, the CPU 451 advances the process from the step S1301 to the step S1302.

In the step S1302, the CPU 451 (grammage restriction unit 1201 and UI unit 461) displays, on the display device 454, a UI in which the selection of the grammage outside the appropriate range is restricted.

In the step S1303, the CPU 451 (UI unit 461) accepts another setting (e.g. single-side printing, double-side printing, or number of sheets to be printed).

In the step S1304, the CPU 451 (job transmitting unit 466) transmits a print job to the image forming apparatus 100. When the print mode is a foil print mode, in principle, a grammage outside the appropriate range is not selectable. Therefore, when the print mode is the foil print mode, a print job in which the grammage outside the appropriate range is not applied is created.

The normal print mode may be selected in the step S1301. In this case, the CPU 451 advances the process from the step S1301 to the step S1311.

In the step S1311, the CPU 451 (grammage restriction unit 1201, UI unit 461) displays a UI in which a grammage outside the recommended grammage range based on a specification of the foil printer 120 is no restricted on the display device 454. That is, the user can select the grammage that is within the recommended grammage range of the image forming apparatus 100, even if the grammage is outside the recommended grammage range of the foil printer 120. The grammage outside the recommended grammage range of the image forming apparatus 100 may still be restricted in selection. After that, the CPU 451 advances the process from the step S1303 to the step S1304.

As described above, in the present embodiment, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### IV Fourth Embodiment

In the fourth embodiment, a case is described in which a selection of a foil print mode and a selection of a grammage can be performed in the image forming apparatus 100. Thus, restricting the selection of the grammage is also performed in the image forming apparatus 100.

FIG. 14 shows a UI 800 for setting the foil print mode that is displayed on the operation unit 40 when the button 701 is pressed. The grammage selection unit 312 displays a list including a plurality of types (grammages) and allows the user to select any of the grammages. Here, a selection of a grammage outside the appropriate range is restricted. Note that, when the normal print mode is selected, the grammage selection unit 312 displays, on the operation unit 40, the setting UI 800 that does not restrict the selection of the grammage outside the appropriate range.

In FIG. 14, the gray out restricts the selection of the grammage outside the appropriate range. These are just examples. The grammage selection unit 312 may remove grammages outside the appropriate range from a plurality of listed options. Accordingly, the grammage outside the appropriate range is not displayed on the grammage selection unit 312, so that the user cannot select the grammage outside the appropriate range. The CPU 401 displays the grammage outside the appropriate range in the grammage selection unit 312, but may ignore the selection of the grammage outside the appropriate range by the user.

FIG. 15 shows a controller of the image forming system 1. The mode determination unit 462 and the grammage restriction unit 1201 are implemented by the CPU 401. The mode determination unit 462 analyzes the print job to determine whether or not the print mode is set to the foil print mode. Alternatively, the mode determination unit 462 determines whether or not the print mode is set to the foil print mode based on an instruction input through the operation unit 40. When the foil print mode is selected, the grammage restriction unit 1201 restricts the selection of the grammage outside the appropriate range in UI displayed on the operation unit 40.

FIG. 16 shows a control method executed by the CPU 401 of the image forming apparatus 100.

In the step S1601, the CPU 401 (mode determination unit 462) determines whether the foil print mode is selected as the print mode. If the foil print mode is selected, the CPU 401 advances the process from the step S1601 to the step S1602.

In the step S1602, the CPU 401 (grammage restriction unit 1201 and UI unit 411) displays, on the operation unit 40, a UI in which the selection of the grammage outside the appropriate range is restricted.

In the step S1603, the CPU 401 (UI unit 411) accepts another setting (e.g. single-side printing, double-side printing, or number of sheets to be printed).

In the step S1604, the CPU 401 (print control unit 413) executes printing according to the print job. When the print mode is the foil print mode, in principle, a grammage outside the appropriate range is not selectable. Therefore, when the print mode is the foil print mode, the grammage outside the appropriate range is not applied.

The normal print mode may be selected in the step S1601. In this case, the CPU 401 advances the process from the step S1601 to the step S1611.

In the step S1611, the CPU 401 (grammage restriction unit 1201 and UI unit 411) displays, on the operation unit 40, a UI in which the selection of the grammage outside the appropriate range is not restricted. That is, the user can select a grammage outside the appropriate range through this UI. As described above, he grammage outside the recommended grammage range of the image forming apparatus 100 may still be restricted in selection. After that, the CPU 401 advances the process from the step S1603 to the step S1604.

As described above, in the present embodiment, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### V. Fifth Embodiment

In the first to fourth embodiments, the foil printer 120 was separated from the image forming apparatus 100. However, the foil printer 120 may be coupled (connected) to the image forming apparatus 100.

FIG. 17 and FIG. 18 show an image forming system 1 including a foil printer 120 and an image forming apparatus 100 connected to each other. FIG. 17 shows that the heating roller 121 and the pressure roller 122 are in a contact state (in a foil processing state). FIG. 18 shows that the heating roller 121 and the pressure roller 122 are in a separation state (state in which foil processing is not executed). That is, the contact state is adopted in the foil print mode. The separation state is adopted in the normal print mode. The motor M1 is a motor for switching between the contact state and the separation state.

The foil processing control unit 414 controls the foil printer 120. When accepting a print job from the information processing apparatus 450, the image forming apparatus 100 forms a toner image in an area to which foil processing is applied on the sheet S, and conveys the sheet S to the foil printer 120 by the conveyance unit 10.

The CPU 401 (foil processing control unit 414) controls the motor M1 to shift the heating roller 121 and the pressure roller 122 from the separation state to the contact state. The foil printer 120 transfers the foil to the toner image on the sheet S by hot pressing and discharges the sheet S to the discharge tray 140. Thus, a foil image is formed on the sheet S. When the foil processing is completed, the CPU 401 (foil processing control unit 414) controls the motor M1 to shift the heating roller 121 and the pressure roller 122 from the contact state to the separation state. This restricts or prohibits the foil processing to the sheet S that does not require the foil processing.

Even when the foil printer 120 and the image forming apparatus 100 are connected in this manner, the inventions described in the first to fourth embodiments can be applied. As a result, the selection of the grammage outside the appropriate range is prohibited in the foil print mode. Therefore, the conveyance error and the wrinkle are less likely to occur, and the productivity of the foil processing is improved. In addition, wasteful consumption of consumables may be suppressed.

### VI. Supplemental Description

The image forming unit 20 is an example of an image forming unit that is provided in the image forming apparatus 100 and forms a toner image on the sheet S as an adhesive. The CPUs 401, 451 are examples of a control unit that controls the image forming unit. The CPUs 401, 451, the operation unit 40, and the input device 455 function as an accepting unit that accepts information about the grammage of the sheet. When a predetermined print mode is selected, the operation unit 40 and the display device 454 display a warning according to the information on the grammage of the sheet. This reduces the possibility that a defect occurs in the adhesion of the foil according to the grammage of the sheet.

The grammage of the sheet S on which the toner image is formed by the image forming apparatus 100 as an adhesive may be a grammage that is not recommended in the image forming system 1 (especially the image forming apparatus 100 or the foil printer 120). In this case, the CPUs 401, 451 suppress the print of the toner image on the sheet. Accordingly, the occurrence of conveyance error or wrinkling of the sheet S in the foil printer 120 is reduced, and the productivity in the foil printer 120 is improved. A grammage that is not recommended is a grammage that is outside the appropriate range and may be referred to as a non recommended grammage. A grammage that is recommended may be referred to as a grammage within an appropriate range.

The warning unit 465, the operation unit 40, and the display device 454 display a warning when the accepted grammage is not recommended grammage. In this way, the warning information may be output so that the user may know the grammage that is not recommended in the foil printer 120 and may refrain from selecting such grammage.

The acquired grammage may be a grammage (a non recommended grammage) that is not recommended in the foil printer 120. In this case, the CPUs 401, 451, the operation unit 40, the input device 455, and the warning UI 600 function as an accepting unit that accepts input of instruction information related to whether or not to continue forming a toner image on the sheet S by the image forming apparatus 100. Since the grammage of the sheet S varies widely, there may be a case where even a sheet S having a non recommended grammage does not cause conveyance error and wrinkles in the foil printer 120. Users may have known such sheet S through their experience. By allowing such a user to continue printing, usability is improved.

As described with reference to FIG. 6, the image forming apparatus 100 may continue forming the toner image on the sheet S having a grammage outside the recommended grammage range when the instruction information indicating that the formation of the toner image on the sheet S is continued is input.

As illustrated in FIG. 6, the grammage change button 604 is an example of an accepting unit that accepts input of instruction information regarding whether to change the grammage of the sheet S when the acquired grammage is a non recommended grammage. Accordingly, the grammage of the sheet S is changed from the recommended grammage to the recommended grammage, so that a defect in the foil processing is unlikely to occur.

As illustrated in FIG. 3B and FIG. 5, the operation unit 40 and the display device 454 may display a screen (e.g. UI 300, setting UI 800) for changing or resetting the grammage of the sheet S when instruction information indicating that the grammage of the sheet S is to be changed is input.

The grammage acquiring unit 463 may acquire the grammage of the sheet S on which the toner image is formed as an adhesive by the image forming apparatus 100 through a screen (e.g. UI 300, setting UI 800) for setting the grammage of the sheet S.

As illustrated in FIG. 3B and FIG. 8, the screen may visually distinguish between a grammage that is not recommended in the image forming apparatus 100 or the foil printer 120 and a grammage that is recommended in the image forming apparatus 100 and the foil printer 120. This will allow the user to visually understand the non recommended grammage and the recommended grammage.

The non recommended grammage may be, for example, the grammage causing a conveyance error in the image forming system 1 or the grammage causing wrinkles in the sheet S in the image forming system 1.

In the image forming system 1, the recommended grammage may be greater than or equal to 90 g/m\hat{ }2 and less than or equal to 350 g/m\hat{ }2. The grammage not recommended in the image forming system 1 may be a grammage outside the recommended grammage range (e.g. a grammage less than 90 g/m\hat{ }2 or greater than 350 g/m\hat{ }2). These values are just examples. The recommended grammage range is set according to the specification of the image forming apparatus 100 and the specification of the foil printer 120.

The grammage that is not recommended in the image forming system 1 may be a grammage that is not recommended in the foil printer 120. This will reduce the occurrence of conveyance error and wrinkles in the foil printer 120.

The grammage not recommended in the image forming system 1 may be a union of the grammage range not recommended in the foil printer 120 and the grammage range not recommended in the image forming apparatus 100. This will reduce the occurrence of conveyance errors and wrinkles in the image forming apparatus 100 and reduce the occurrence of conveyance errors and wrinkles in the foil printer 120. Note that, the appropriate range in the image forming system 1 may be a common part (intersection) of the recommended grammage range of the foil printer 120 and the recommended grammage range of the image forming apparatus 100.

As illustrated in FIG. 3B, FIG. 8, FIG. 11, and FIG. 14, the tab 302 and the setting UI 800 are examples of an accepting unit that accepts input of the grammage of the sheet S on which the toner image is formed. The CPUs 401, 451 may restrict input of the non recommended grammage through the accepting unit.

As illustrated in FIG. 11 and FIG. 14, the tab 302 and the setting UI 800 are examples of screens for accepting input of grammage information (e.g. plain paper, 90 g/m\hat{ }2 to 105 g/m\hat{ }2) indicating the grammage of the sheet on which the toner image is formed. The tab 302 and the setting UI 800 may not display the non recommended grammage as selectable candidates (e.g., grayed out), and may display the recommended grammage as selectable candidates.

The CPU 401 may control the accepting unit such that, when the predetermined print mode is selected, the sheet of the first grammage is selectable and the sheet of the second grammage differing from the first grammage is not selectable.

The communication circuit 453 functions as a transmitting unit that transmits a job for forming a toner image on the sheet S to the image forming apparatus 100 as an adhesive for adhering the foil to the sheet S in the foil printer 120. The CPU 451 functions as a control unit that controls the image forming apparatus 100 through the communication circuit 453. The CPU 451 may function as a selection unit for selecting a predetermined print mode for forming the toner image for adhering the foil over the sheet via the toner image. The CPU 451 may function as an accepting unit that accepts information about the grammage of the sheet. The CPU 451 may function as a display control unit that, when a predetermined print mode is selected, causes the display unit to display a warning according to the information regarding the grammage of the sheet.

There is a case in which a predetermined print mode is selected when accepting information on the grammage of the sheet. Here, the CPU 451 may act that a sheet of a first grammage is selectable and a sheet of a second grammage that differs from the first grammage is unselectable.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-060400, filed Apr. 3, 2024 which is hereby incorporated by reference herein in its entirety.

What is claimed is:

1. An image forming apparatus comprising:
an input unit configured to accept a selection of a predetermined print mode for forming a toner image for adhering foil onto a sheet via the toner image and an input of information related to a grammage of the sheet;
an image forming unit configured to form the toner image on the sheet; and
a display unit configured to display a warning according to the information related to the grammage of the sheet in a case where the predetermined print mode is selected.

2. The image forming apparatus according to claim 1, wherein
the display unit is further configured to display the warning in a case where the grammage is a non recommended grammage in the image forming apparatus or a foil printer.

3. The image forming apparatus according to claim 2, wherein
the input unit is further configured to accept an input of instruction information indicating whether to continue formation of the toner image on the sheet by the image forming apparatus in a case where the grammage is the non recommended grammage.

4. The image forming apparatus according to claim 3, wherein
the image forming apparatus is further configured to continue forming the toner image on the sheet of the non grammage recommended in a case where the instruction information indicating that the formation of the toner image on the sheet is continued.

5. The image forming apparatus according to claim 2, wherein
the input unit is further configured to accept an input of instruction information related to whether to change the grammage of the sheet in a case where the grammage is the non-recommended grammage.

6. The image forming apparatus according to claim 5, wherein
the display unit is further configured to display a screen for changing or resetting the grammage of the sheet in a case where the instruction information indicating that the grammage of the sheet is changed is input.

7. The image forming apparatus according to claim 2, wherein
the input unit is further configured to acquire the grammage of the sheet on which the toner image is formed as an adhesive of the foil by image forming apparatus through a screen for setting the grammage of the sheet.

8. The image forming apparatus according to claim 6, wherein
the screen is further configured to display and visually distinguish between a grammage that is not recommended in the image forming apparatus or the foil printer and a grammage that is recommended in the image forming apparatus and the foil printer.

9. The image forming apparatus according to claim 2, wherein
the grammage which is not recommended in image forming apparatus or foil printer is the grammage which causes conveyance failure in image forming apparatus or the foil printer, or the grammage which causes wrinkles in the sheet in image forming apparatus or the foil printer.

10. The image forming apparatus according to claim 2, wherein
a recommended grammage range recommended in the image forming apparatus and the foil printer is 90 g/m\hat{ }2 or more and 350 g/m\hat{ }2 or less, and a grammage not recommended in the image forming apparatus or the foil printer is a grammage outside the recommended grammage range.

11. The image forming apparatus according to claim 2, wherein
the non recommended grammage is a union of a grammage range not recommended in the foil printer and a grammage range not recommended in the image forming apparatus, and the recommended grammage is a common part of a grammage range recommended in the foil printer and a grammage range recommended in image forming apparatus.

12. The image forming apparatus according to claim 2, further comprising
a controller configured to control the input unit such that an input of the non-recommended grammage is restricted.

13. The image forming apparatus according to claim 2, wherein
the display unit is further configured to display a screen for accepting an input of grammage information indicating a grammage of the sheet on which the toner image is formed by the image forming unit, and
the display unit is further configured to not display the non recommended grammage as a selectable candidate on the screen, but to display the recommended grammage as a selectable candidate in a case where the warning is displayed.

14. An image forming apparatus comprising:
an input unit configured to accept a selection of a predetermined print mode for forming a toner image for adhering foil onto a sheet via the toner image among a plurality of print modes and an input of information related to a grammage of the sheet;
an image forming unit configured to form the toner image on the sheet; and
a controller configured to control the input unit such that a sheet having a first grammage can be selected via the input unit and a sheet having a second grammage different from the first grammage cannot be selected via the input unit in a case where the predetermined print mode is selected.

15. An image forming system comprising:
an image forming apparatus;
a foil printer configured to adhere foil onto a sheet via a toner image formed on the sheet by the image forming apparatus;
wherein the image forming apparatus comprising:
an input unit configured to accept a selection of a predetermined print mode for forming a toner image for adhering foil onto a sheet via the toner image and an input of information related to a grammage of the sheet;
an image forming unit configured to form the toner image on the sheet; and
a display unit configured to display a warning according to the information related to the grammage of the sheet in a case where the predetermined print mode is selected.

16. An information processing apparatus comprising:
a transmitting unit configured to transmit a job for forming a toner image on a sheet as an adhesive for adhering foil onto the sheet in a foil printer to an image forming apparatus; and
a controller configured to control the image forming apparatus via the transmitting unit;
wherein the controller is further configured to:
select a predetermined print mode for forming a toner image for adhering foil onto a sheet via the toner image;
accept information related to a grammage of the sheet; and
cause a display unit to display a warning according to the information related to the grammage of the sheet in a case where the predetermined print mode is selected.

17. An information processing apparatus comprising:
a transmitting unit configured to transmit a job for forming a toner image on a sheet as an adhesive for adhering foil onto the sheet in a foil printer to an image forming apparatus; and
a controller configured to control the image forming apparatus via the transmitting unit;
wherein the controller is further configured to:
select a predetermined print mode for forming a toner image for adhering foil onto a sheet via the toner image;
accept information related to a grammage of the sheet;
act such that a sheet of a first grammage is selectable and a sheet of a second grammage that differs from the first grammage is unselectable in a case where the predetermined print mode is selected when accepting information related to the grammage of the sheet.
